(19) United States
(12) Patent Application Publication
(10) Pub. No.: US 2025/0374860 A1
(43) Pub. Date: Dec. 11, 2025

(54) BALE BUNDLE TREATMENT SYSTEM

(71) Applicant: Marcrest Manufacturing Inc., Listowel (CA)

(72) Inventors: Mark HORST, Listowel (CA); Keith HORST, Listowel (CA); Collin ZETTLER, Listowel (CA); Cameron VAN DONKERSGOED, Listowel (CA)

(21) Appl. No.: 19/231,843

(22) Filed: Jun. 9, 2025

Related U.S. Application Data
(60) Provisional application No. 63/657,197, filed on Jun. 7, 2024.

(51) Int. Cl. A01D 85/00

(52) U.S. Cl. CPC A01D 85/00

(57) ABSTRACT

A system including a body assembly having an interior surface partially defining an interior space therein, and a floor assembly in the interior space to divide the interior space into a lower duct below the floor assembly, and an upper portion above the floor assembly. When one or more bale bundles are positioned on the floor assembly, the bale bundles at least partially define an upper duct in the upper portion, the upper duct being between the bale bundles and a portion of the interior surface. The system also includes an engagement assembly configured for at least partially compressing the bale bundles positioned on the floor assembly. When an air flow is directed through the bale bundles while the bale bundles are partially compressed by the engagement assembly, the air flow effects a change in a moisture content of the bale bundles.

### CROSS-REFERENCE TO RELATED APPLICATION

This application claims the benefit of U.S. Provisional Patent Applicant No. 63/657,197, filed on Jun. 7, 2024, the entirety of which provisional patent application is hereby incorporated herein by reference.

### FIELD OF THE INVENTION

The present invention is a system for changing a moisture content of a bale bundle of crop material.

### BACKGROUND OF THE INVENTION

As is well known in the art, bales of crop material or forage (e.g., hay) should have moisture content within a specific range when they are stored, otherwise mould may grow in the bales. Depending on a number of factors (e.g., type of crop material, and ambient conditions), bales of crop material that are compressed to a relatively high density should have a moisture content of less than a certain predetermined percentage by weight before storage. In many cases, it is sufficient if the crop material is field-dried.

However, it is sometimes necessary to dry the bales before storage. For instance, the crop material may be baled at a higher moisture content than is desirable in order to avoid exposing the crop material to rain. Alternatively, it may be sought to obtain a higher quality product, that may not be produced by field drying only. Accordingly, bales may be dried using conventional methods. However, the known drying methods have a number of disadvantages. In particular, conventional drying methods tend to produce somewhat inconsistent moisture content at different locations throughout the bales.

Rectangular bales may be attached together to form a bale bundle. However, in prior art bale dryers, the bales inside the bale bundles tend to separate from each other when in the dryer, opening channels therebetween through which heated air tends to travel. When this happens, the bale bundle does not dry properly throughout the bale bundle, because the heated air is not directed throughout the entire bale bundle.

### SUMMARY OF THE INVENTION

For the foregoing reasons, there is a need for a bale bundle treatment system that overcomes or mitigates one or more of the defects or disadvantages of the prior art.

In its broad aspect, the invention provides a system including a body assembly having an interior surface partially defining an interior space therein, and a floor assembly in the interior space to divide the interior space into a lower duct below the floor assembly, and an upper portion above the floor assembly. When one or more bale bundles are positioned on the floor assembly, the bale bundles at least partially define an upper duct in the upper portion that is between the bale bundles and a portion of the interior surface. The system also includes an engagement assembly configured for at least partially compressing the bale bundles positioned on the floor assembly. When an air flow is directed through the bale bundles while the bale bundles are partially compressed by the engagement assembly, the air flow effects a change in a moisture content of the bale bundles.

### BRIEF DESCRIPTION OF THE DRAWINGS

The invention will be better understood with reference to the attached drawings, in which:

FIG. 1A is an isometric view of an embodiment of a system of the invention including a subsystem having a body assembly defining an interior space therein, and an air flow control assembly, excluding a fan-heater assembly;

FIG. 1B is a top view of the subsystem of FIG. 1A, drawn at a larger scale;

FIG. 1C is a longitudinal section of the subsystem as illustrated in FIG. 1B, taken along line A-A′ in FIG. 1B, showing air flow therethrough when the system operates in normal mode;

FIG. 1D is a cross-section of the subsystem as illustrated in FIG. 1B taken along line B-B′ in FIG. 1B, drawn at a larger scale;

FIG. 1E is an end view of a first end of the subsystem of FIG. 1B, drawn at a smaller scale;

FIG. 1F is an isometric view of a portion of the subsystem of FIG. 1A with a cover subassembly thereof partially omitted, drawn at a smaller scale;

FIG. 1G is a longitudinal section of the an embodiment of the system including an embodiment of the fan-heater assembly thereof in which the system is operational in normal mode, drawn at a smaller scale;

FIG. 1H is a longitudinal section of the system of FIG. 1G in which the system is operational in reverse mode;

FIG. 2A is a side view of the subsystem of FIG. 1B with the cover subassembly thereof omitted, to show post elements, moving elements, and linkage arms of an embodiment of an engagement assembly of the invention, drawn at a larger scale;

FIG. 2B is portion of the subsystem of FIG. 2A, drawn at a larger scale;

FIG. 2C is an isometric view of the subsystem of FIGS. 2A and 2B, drawn at a smaller scale;

FIG. 2D is another isometric view of the subsystem of FIGS. 2A-2C;

FIG. 2E is an isometric view of certain elements of an embodiment of an intermediate subassembly of the engagement assembly, drawn at a larger scale;

FIG. 3 is an isometric view of the subsystem of FIG. 1B with the cover subassembly thereof omitted, drawn at a smaller scale;

FIG. 4A is an isometric view of the subsystem of FIG. 1B with cover panels of the cover subassembly omitted, to show support elements of the cover subassembly, drawn at a smaller scale;

FIG. 4B is an isometric view of the subsystem of FIG. 4A with bale bundles positioned therein;

FIG. 4C is a side view of the subsystem of FIG. 4A;

FIG. 4D is a top view of the subsystem of FIGS. 4A and 4C;

FIG. 4E is an end view of the second end of the subsystem of FIG. 4A, drawn at a larger scale;

FIG. 5A is an end view of a second end of the subsystem of FIG. 4B with bale bundles positioned therein showing the engagement assembly in a disengaged condition thereof, drawn at a larger scale;

FIG. 5B is another end view of the subsystem and the bale bundles of FIG. 5A in which the engagement assembly is in a first intermediate condition thereof;

FIG. 5C is another end view of the subsystem and the bale bundles of FIGS. 5A and 5B in which the engagement assembly is in a second intermediate condition thereof;

FIG. 5D is another end view of the subsystem and the bale bundles of FIGS. 5A-5C in which the engagement assembly is in a third intermediate condition thereof and side pressure bars of the engagement assembly are pivoted toward side surfaces of the bale bundles;

FIG. 5E is another end view of the subsystem and the bale bundles of FIGS. 5A-5D in which the engagement assembly is in an engaged condition thereof;

FIG. 5F is the end view of the subsystem and the bale bundles of FIG. 5E in which the flow of heated air upwardly through the bale bundles when the system in operating in normal mode is schematically illustrated;

FIG. 5G is an end view of an embodiment of a side seal subassembly of the invention, drawn at a larger scale;

FIG. 6A is a top view of the subsystem of FIG. 4B, with the bale bundles positioned therein, drawn at a smaller scale;

FIG. 6B is a longitudinal section of the subsystem of FIG. 6A with the bale bundles positioned therein showing air flow therein when the system operates in normal mode;

FIG. 6C is an isometric view of the system of FIGS. 6A and 6B, drawn at a larger scale;

FIG. 7A is an isometric view of an embodiment of a flap element adjustment assembly of the invention in a closed position thereof, drawn at a larger scale;

FIG. 7B is an isometric view of the flap element adjustment assembly of FIG. 7A in an open position;

FIG. 7C is another isometric view of the flap element adjustment assembly of FIG. 7B;

FIG. 7D is another isometric view of the flap element adjustment assembly of FIGS. 7B and 7C, drawn at a larger scale;

FIG. 7E is another isometric view of the flap element adjustment assembly of FIGS. 7B-7D;

FIG. 8A is an isometric view of an embodiment of an air flow control assembly of the invention connected with the subsystem of FIGS. 1B and 1C, drawn at a smaller scale;

FIG. 8B is a side view of the air flow control assembly of FIG. 8A, with certain side panels of an air flow control housing of the air flow control assembly removed, showing an air flow control door thereof in a down position thereof;

FIG. 8C is a longitudinal section of the air flow control assembly of FIG. 8B in which the air flow control door is in the down position thereof, drawn at a larger scale;

FIG. 8D is a portion of the longitudinal section of FIG. 8C showing the downstream end of the air flow control door when the air flow control door is in the down position, drawn at a larger scale;

FIG. 8E is a portion of the longitudinal section of FIG. 8C showing the upstream end of the air flow control door when the air flow control door is in the down position;

FIG. 9A is an isometric view of part of the air flow control door in the down position, drawn at a smaller scale;

FIG. 9B is an isometric view of a part of the air flow control door in the down position, drawn at a larger scale;

FIG. 10A is a side view of the air flow control assembly of FIG. 8A, with certain side panels of the air flow control housing removed, showing an air flow control door thereof in an up position thereof;

larger scale;

FIG. 10B is an isometric view of the air flow control door of FIG. 10A, drawn at a

FIG. 10C is an isometric view of an upstream end of the air flow control door of FIG. 10A, drawn at a larger scale;

FIG. 10D is another isometric view of the air flow control door of FIG. 10A, drawn at a smaller scale;

FIG. 10E is a schematic illustration of part of the air flow control door located between panels of the air flow control housing; and

FIG. 11 is an isometric view of the air flow control door in the up position in the air flow control assembly, drawn at a smaller scale.

### DETAILED DESCRIPTION

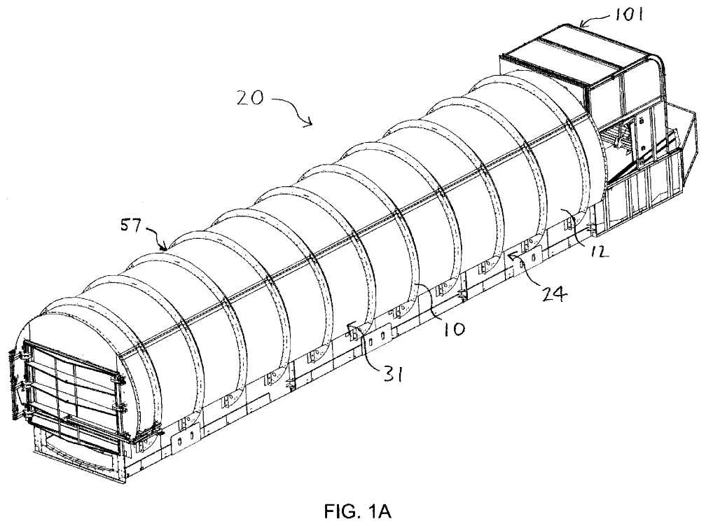

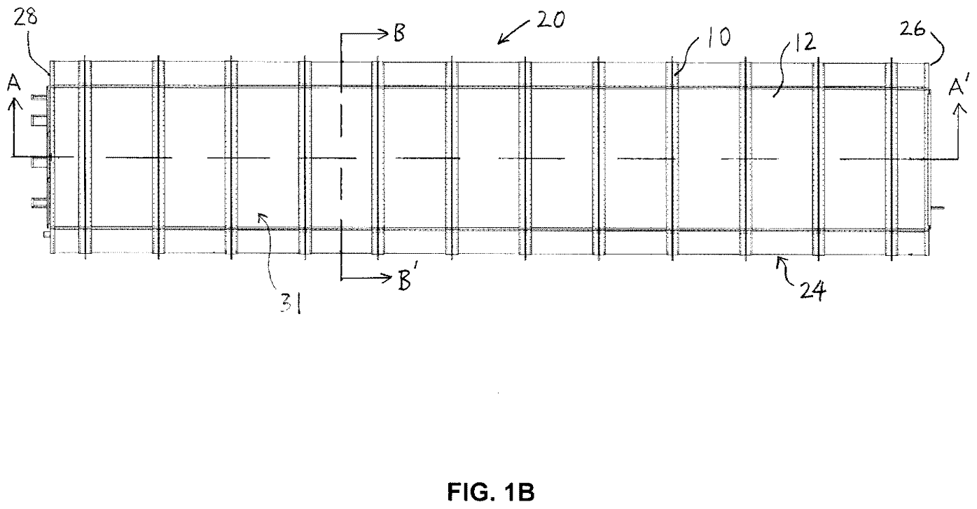

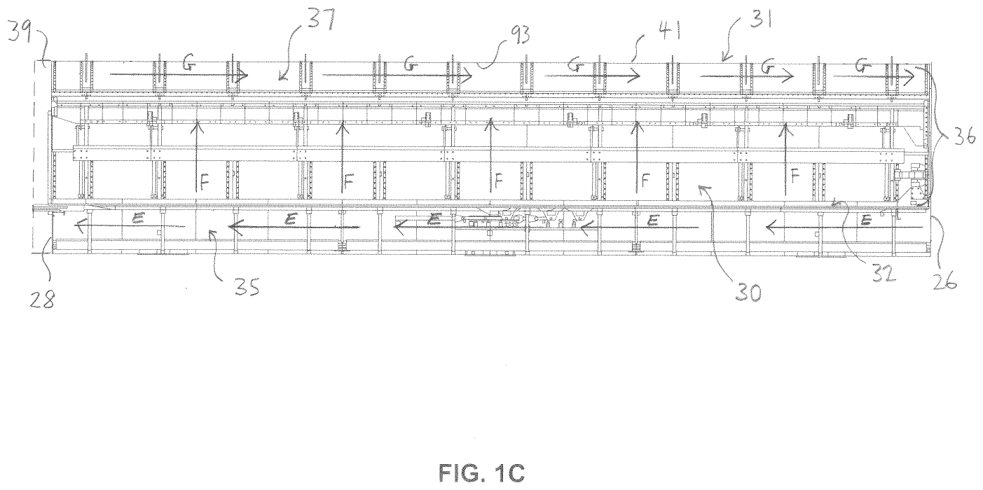

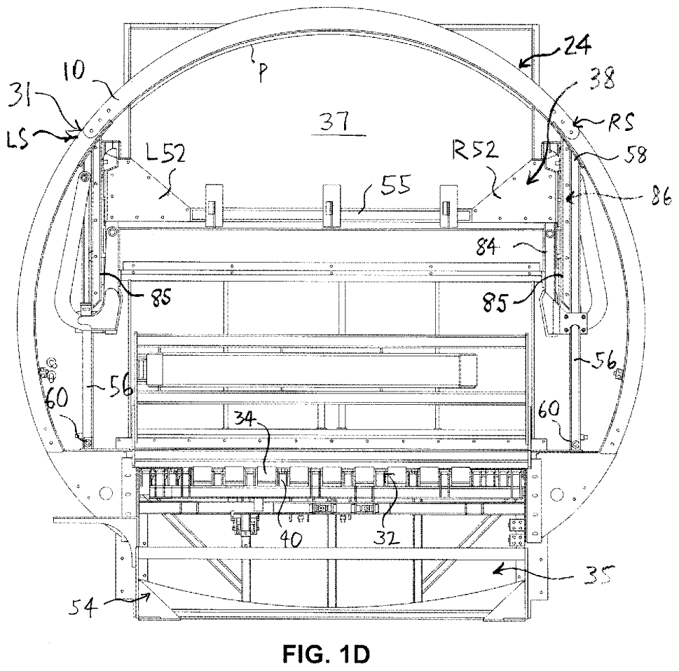

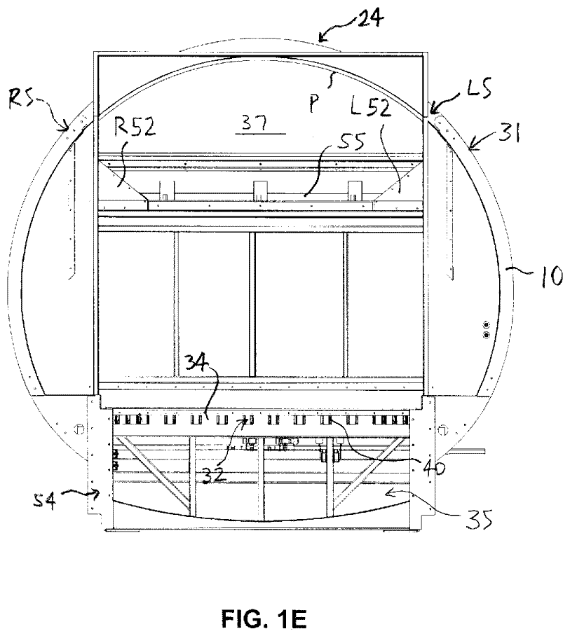

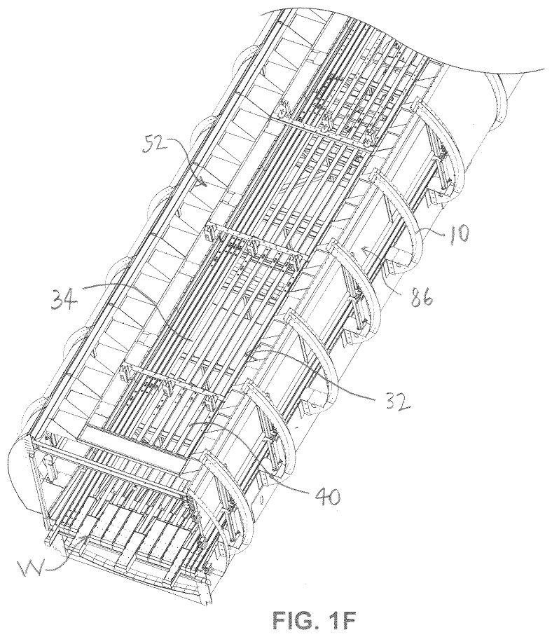

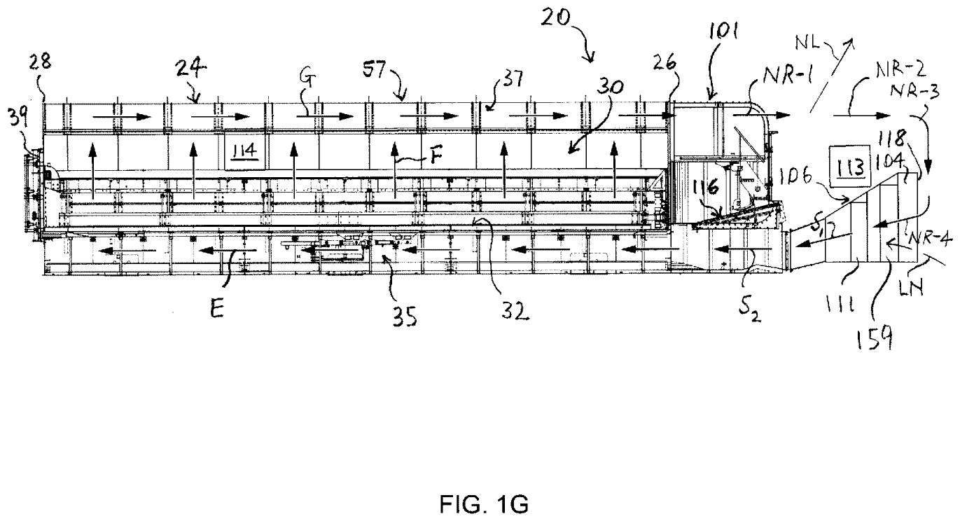

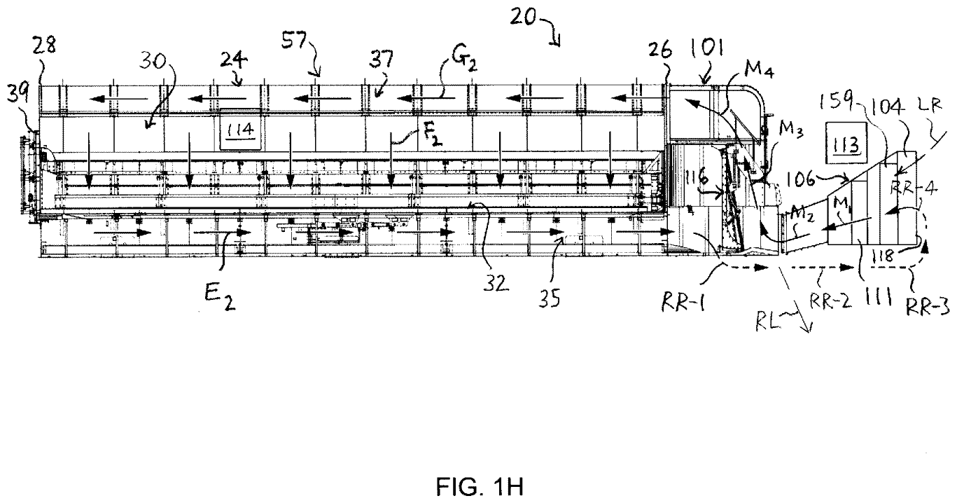

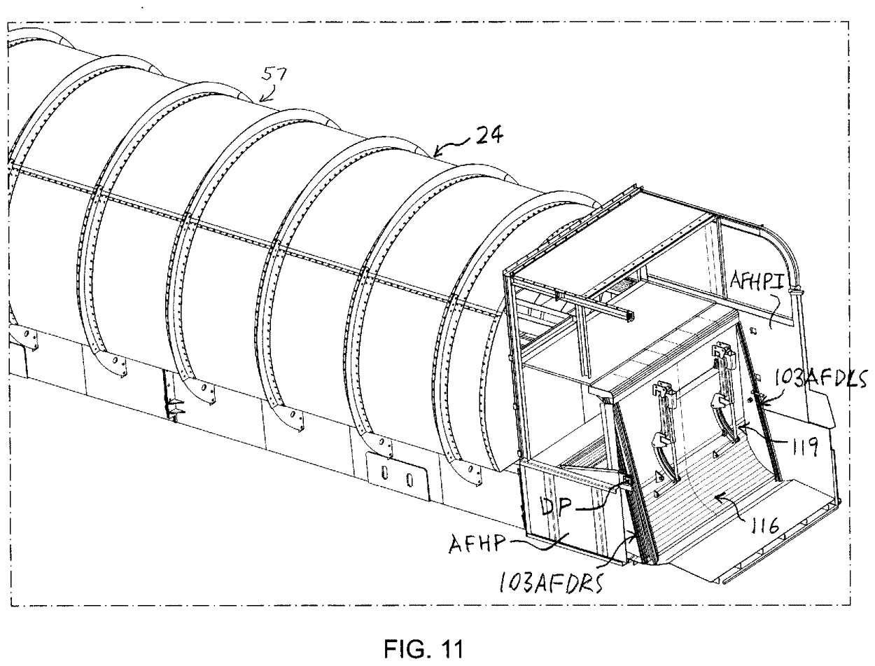

In the attached drawings, like reference numerals designate corresponding elements throughout. Reference is made to FIGS. 1A-11 to describe an embodiment of a system in accordance with the invention indicated generally by the numeral 20.

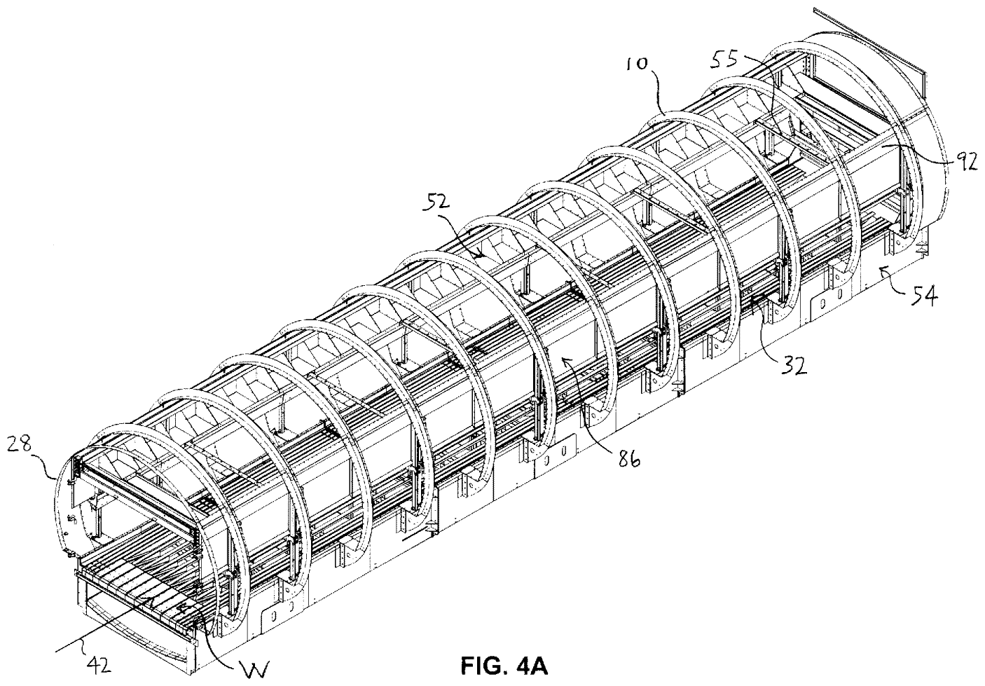

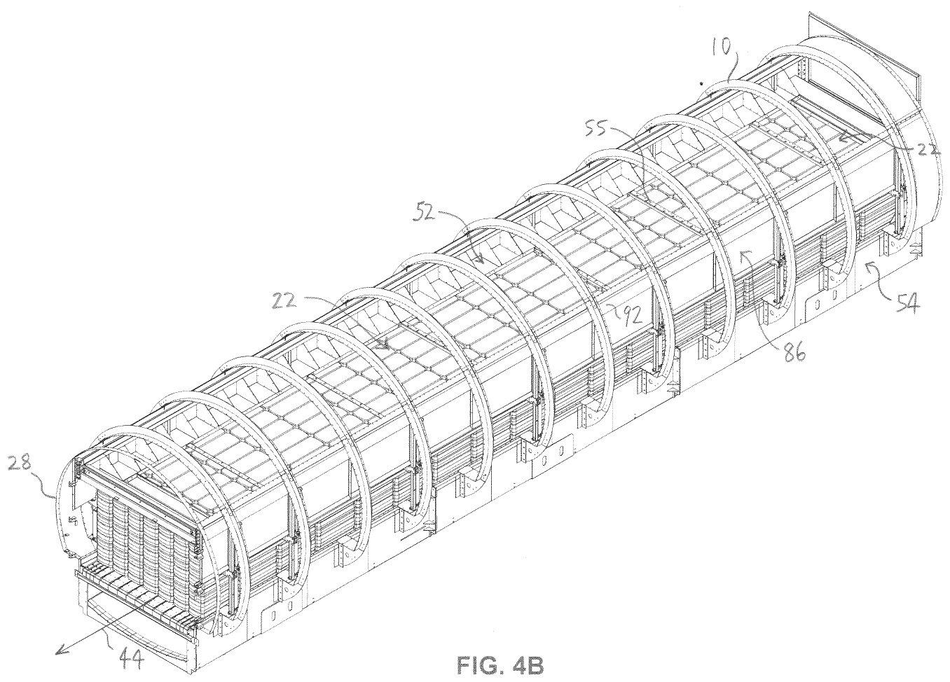

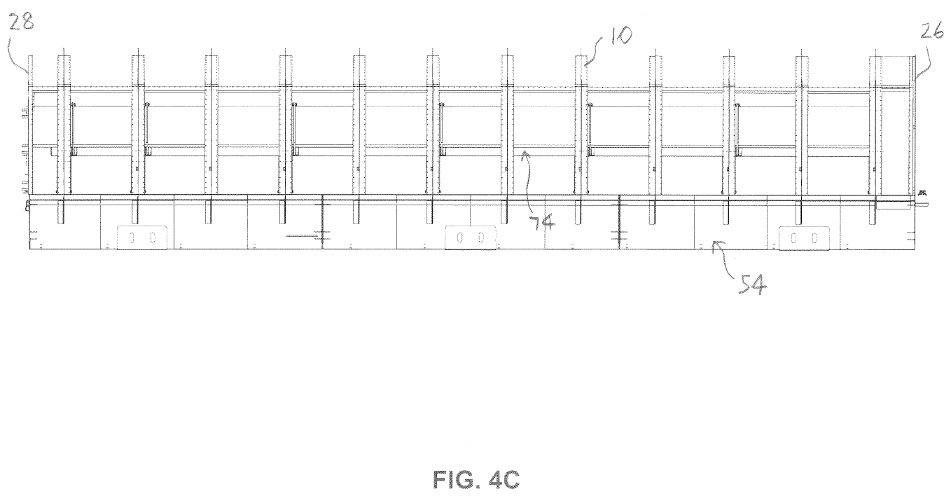

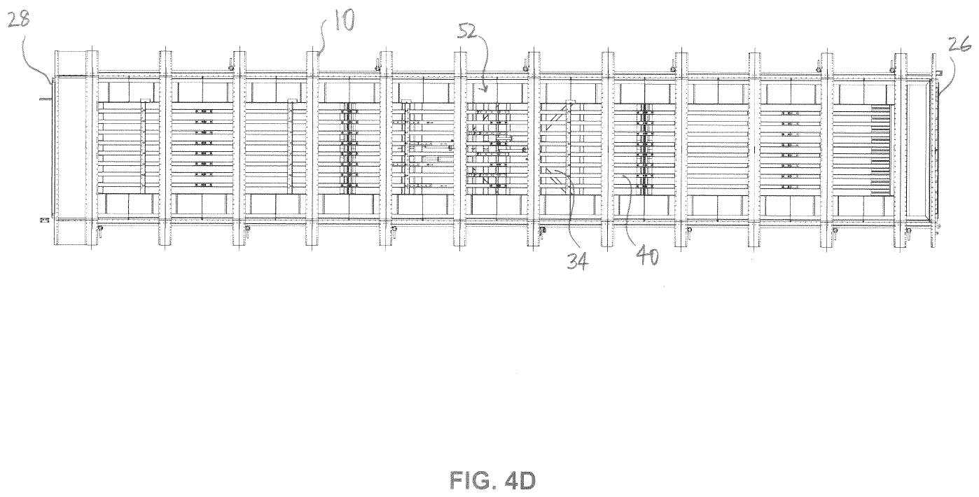

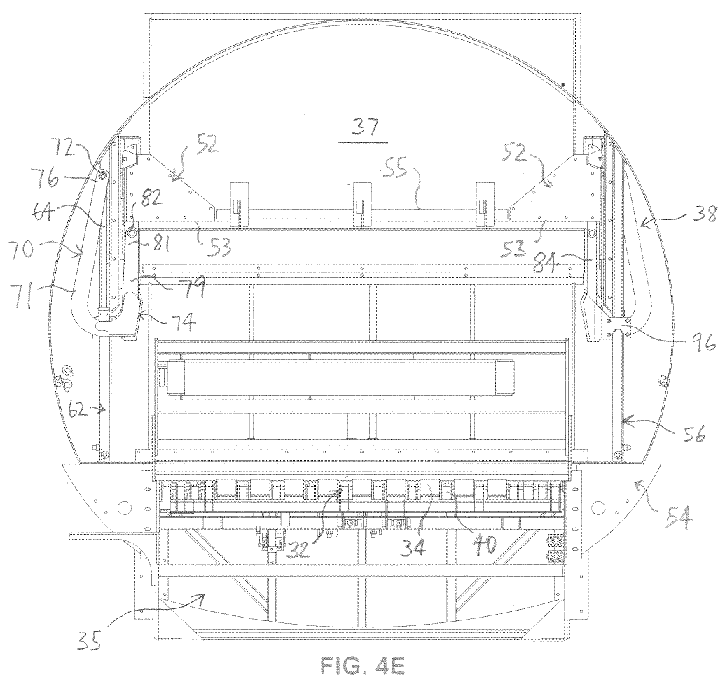

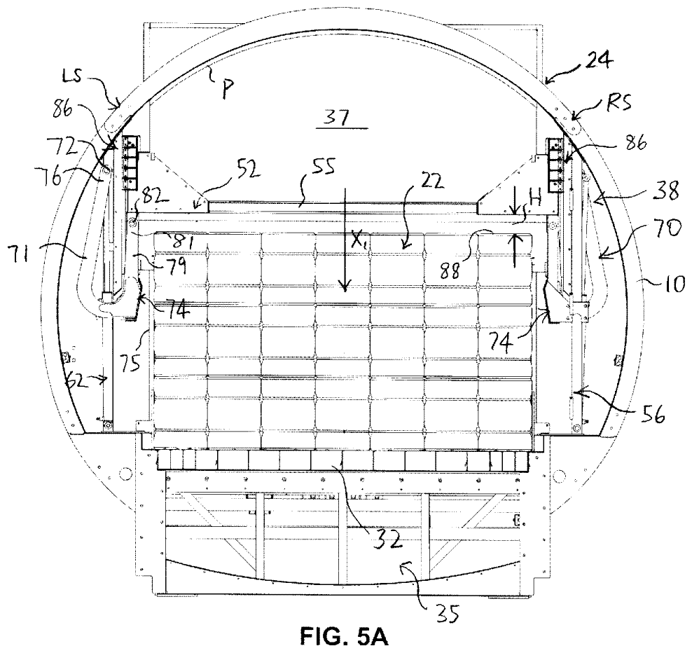

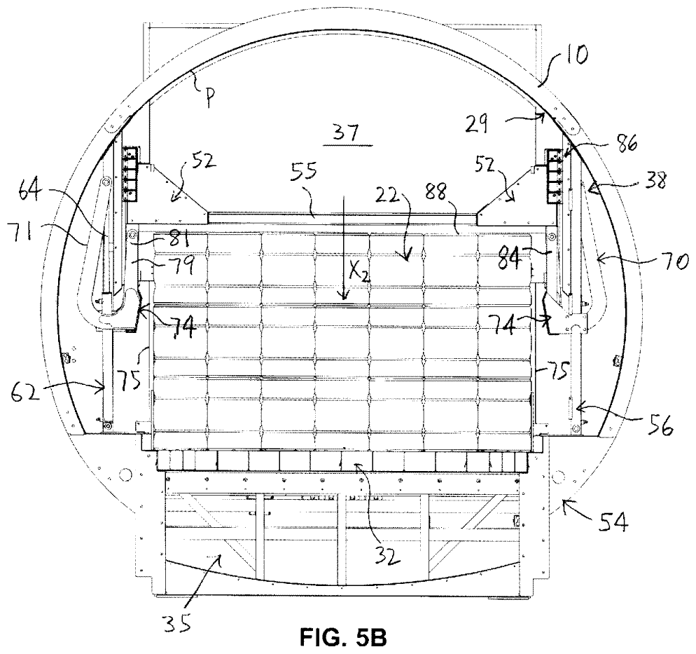

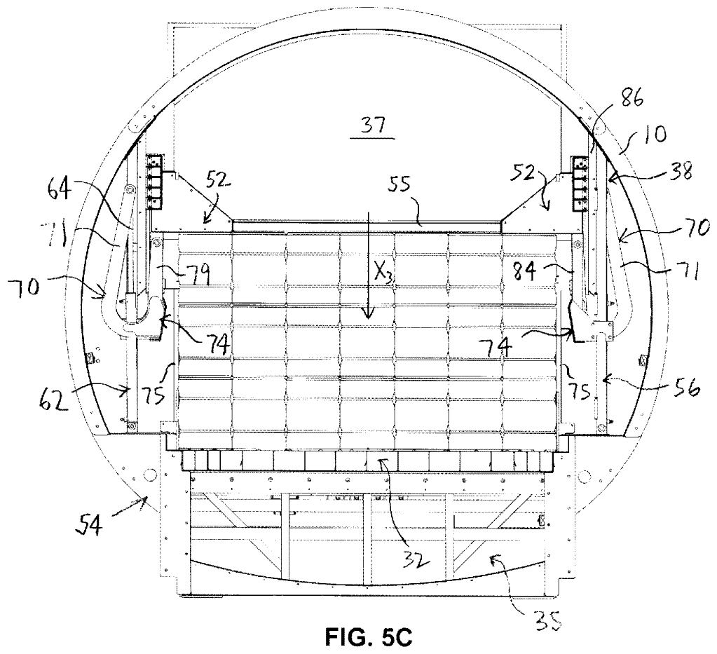

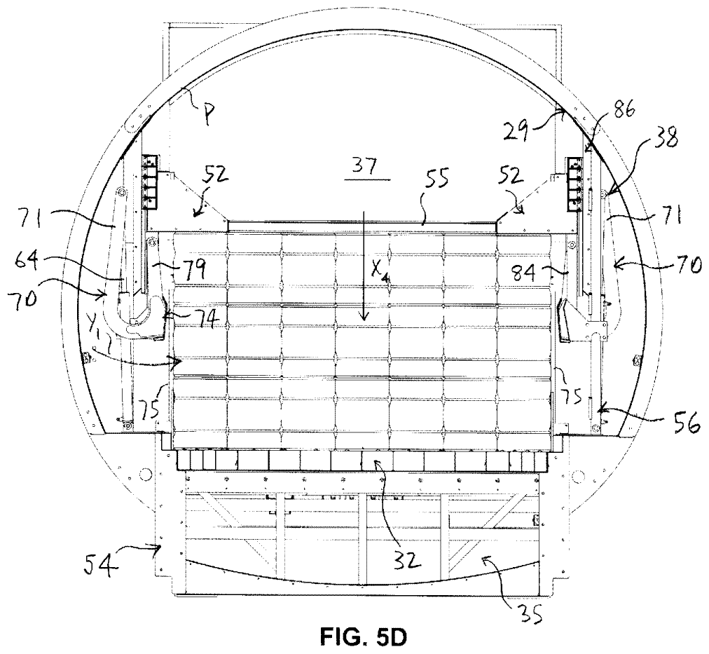

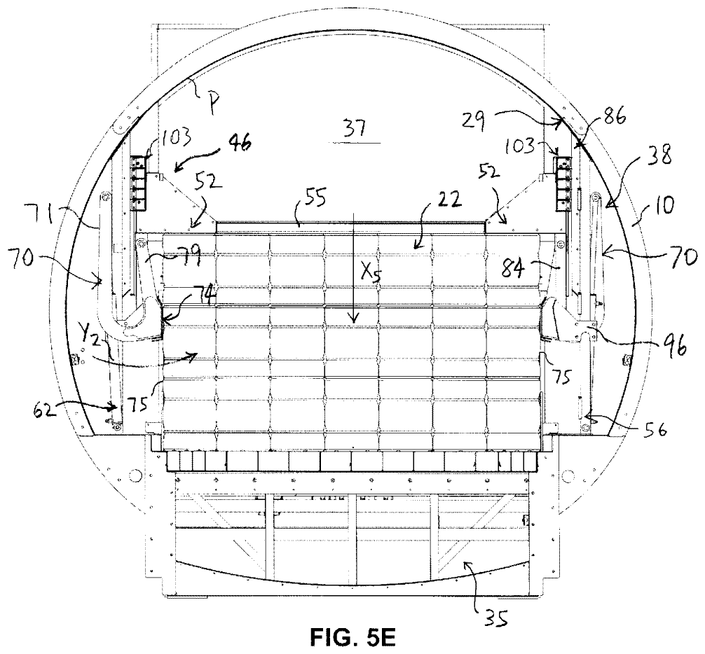

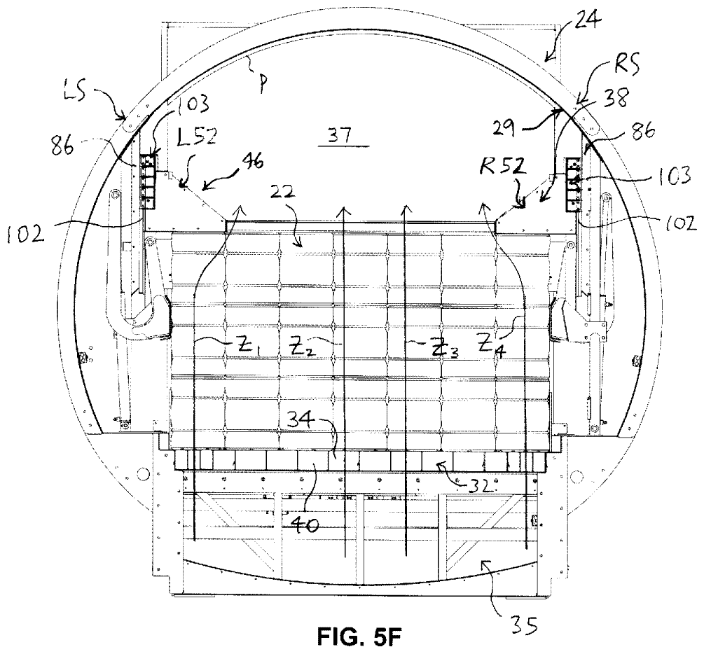

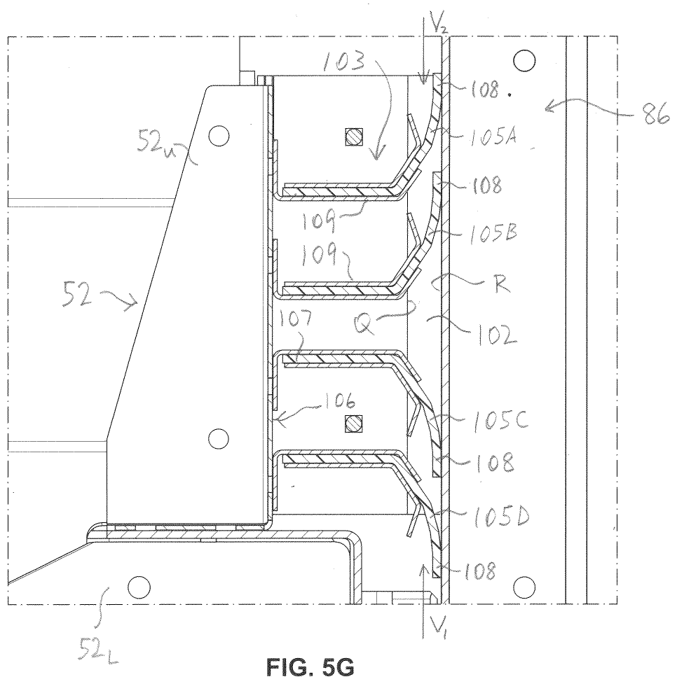

The system 20 is for treatment of one or more bale bundles 22 of crop material, for changing a moisture content of the one or more bale bundles 22 (FIG. 4B). As will be described, the system 20 may be utilized for decreasing the moisture content, or increasing the moisture content. As can be seen in FIGS. 1A and 1B, in one embodiment, the system 20 preferably includes a body assembly 24 extending between first and second ends 26, 28 thereof. The body assembly 24 has an interior surface 29 thereof that partially defines an interior space 30 therein (FIGS. 5E, 5F).

Preferably, the system 20 also includes a floor assembly 32 with a plurality of openings 34 therein, for supporting the bale bundles 22 positioned in the interior space 30 (FIGS. 1C, 1F). As can be seen in FIG. 1C, the floor assembly 32 preferably is located in the interior space 30. Preferably, the floor assembly 32 divides the interior space 30 into a lower duct 35 located below the floor assembly 32, and an upper portion 36 located above the floor assembly 32 (FIG. 1C). When the one or more bale bundles 22 are positioned on the floor assembly 32, the one or more bale bundles 22 partially define an upper duct 37 in the upper portion 36. The upper duct 37 is at least partially defined between the one or more bale bundles 22 and a portion “P” of the interior surface 29 that is above the one or more bales 22 (FIGS. 1C, 1D).

It is also preferred that the system 20 includes an engagement assembly 38 (FIG. 1D) that extends inside the body assembly 24 between the first and second ends 26, 28 and that is configured for at least partially compressing the bale bundles 22 on the floor assembly 32. As will be described, it is preferred that an air flow is directed through the one or more bale bundles 22 while the one or more bale bundles are at least partially compressed by the engagement assembly 38, for changing a moisture content of the one or more bale bundles.

As can be seen in FIGS. 1G and 1H, the system 20 preferably includes one or more fans 104 for creating the air flow. It is also preferred that the one or more fans 104 are included in a fan-heater assembly 106 (FIGS. 1G, 1H). Those skilled in the art would appreciate that one fan alone may be sufficient.

In one embodiment, the system 20 preferably includes one or more heaters 111, for heating air in the air flow to a predetermined temperature (FIGS. 1G, 1H). Preferably, the one or more heaters are also included in the fan-heater assembly 106.

In one embodiment, the system 20 preferably also includes a fan controller 113 for controlling the fans 104 (FIGS. 1G, 1H). Those skilled in the art would be aware of suitable fan controllers. The system 20 preferably also includes one or more moisture measurement devices 114, for measuring the moisture content of the bale bundles positioned on the floor assembly. The fan controller 113 preferably is configured for de-energizing the fan 104 when the moisture content is equal to a preselected target moisture content. Those skilled in the art would appreciate that the controller 113 may be configured to operate automatically, and it may alternatively be controlled manually.

Those skilled in the art would appreciate that, as a practical matter, the preselected target moisture content may be a selected range of moisture contents, rather than a single moisture content value.

As will also be described, the system preferably also includes an air flow control assembly 101 configured to direct the air flow into a selected one of the lower duct 35 and the upper duct 37 at the first end 26 of the body assembly 24. The air flow may be directed into the lower duct 35 or the upper duct 37, as the case may be, in order that the moisture content of the bale bundles positioned on the floor assembly 32 is equal to the preselected target moisture content throughout the bale bundles. For example, in FIGS. 1C and 1G, the air flow through the lower duct 35 and the upper portion 36 is schematically represented by arrows “E”, “F”, and “G”.

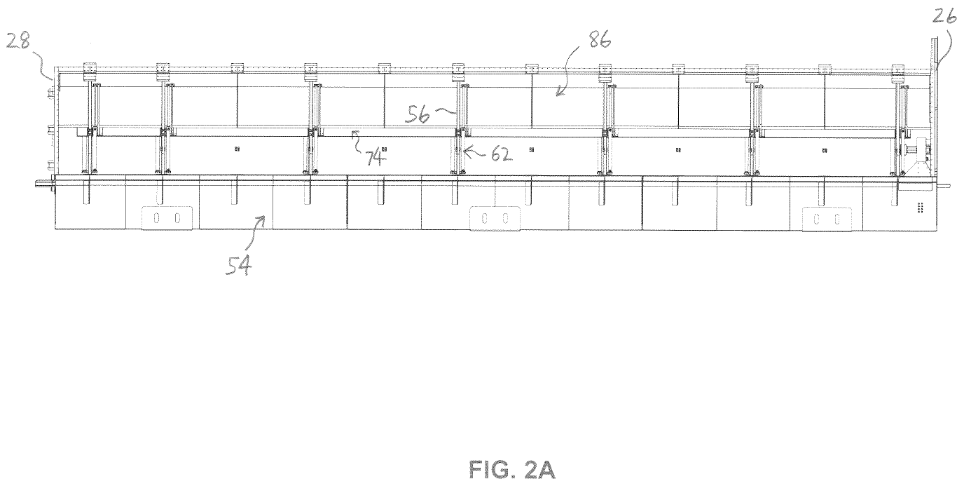

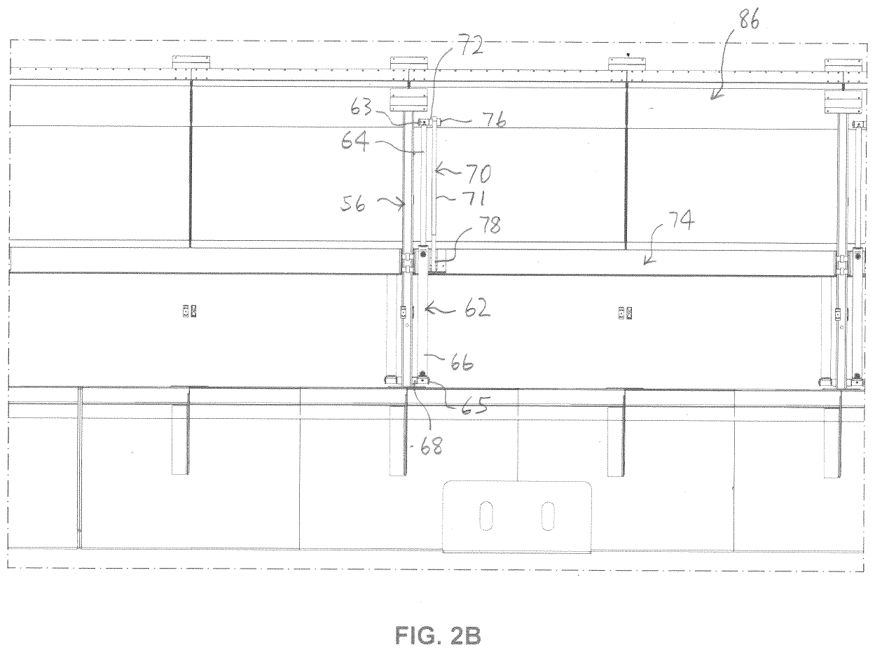

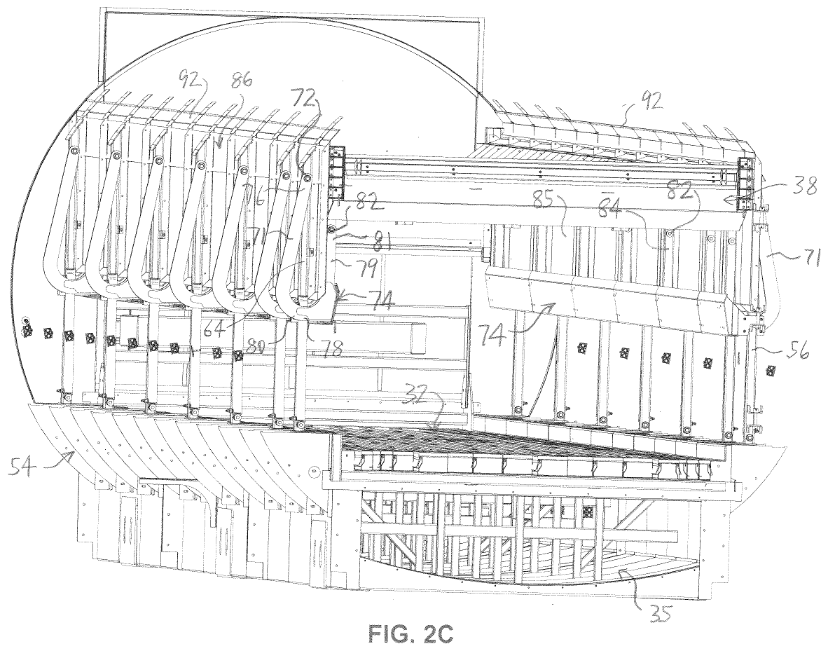

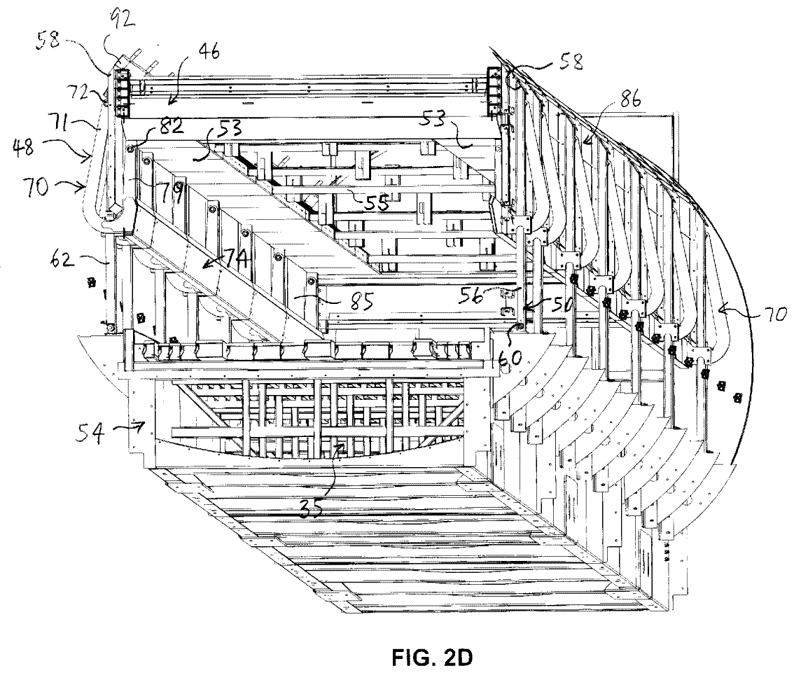

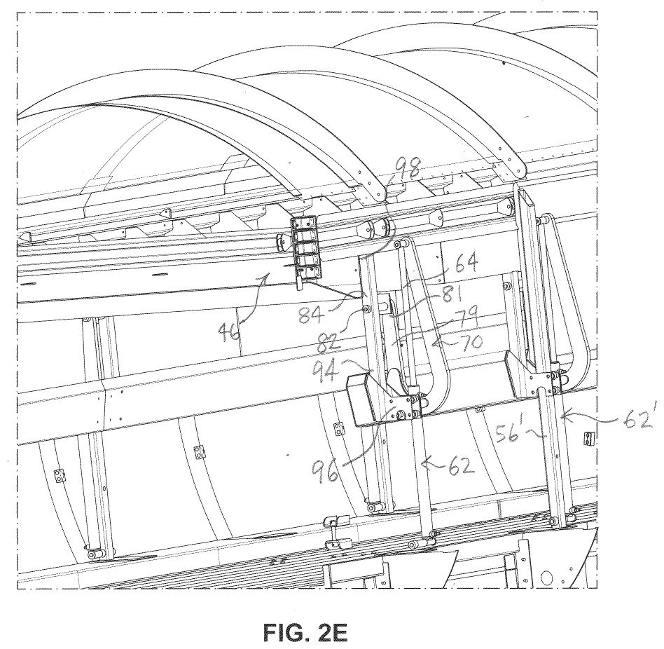

For the purposes hereof, the system 20, when the air flow control assembly 101 and the fan-heater assembly 106 are excluded, is sometimes referred to herein as a subsystem 57 (FIGS. 1A-1C, 2A)

From the foregoing, it can be seen that the air flow preferably is directed by the fan 104 into the air flow control assembly 101 (FIGS. 1A and 1G). In the example illustrated in FIG. 1G, the air flow is directed by the air flow control assembly 101 into the lower duct 35 at the first end 26. As can be seen in FIGS. 1C and 1G, in the configuration illustrated therein, in the body assembly, the air flow is directed upwardly from the lower duct 35 through the floor assembly 32 and through the bale bundles positioned thereon, and hence upwardly into the upper duct 37. In this configuration, the air flow exits the upper duct 37 at the first end 26, and the air flow may thereafter be directed to the fan-heater assembly 106 for recirculation, as will be described.

In an alternative configuration of the system 20, the air flow may be directed in a reverse direction into the upper duct 37 at the first end 26 by the air flow control assembly 101 (FIG. 1H). In this alternative configuration, the air flow through the upper duct 37 is in the direction indicated by arrows “G₂”. The air flows downwardly through the bale bundles (not shown in FIG. 1H) in the directions indicated by arrows “F₂”, and the air flows through the lower duct 35 in the directions indicated by arrows “E₂” in FIG. 1H. In short, in this configuration the air flow through the interior space 30 is in reverse directions relative those respectively indicated in FIGS. 1C and 1G.

From the foregoing, it can be seen that the system 20 may operate in two different modes of operation. For the purposes hereof, the operation of the system 20 to produce the air flow as illustrated in FIGS. 10, 1G, 5F, and 6B is referred to as “normal operation”, and the operation of the system 20 to produce the air flow as illustrated in FIG. 1H is referred to as “reverse operation”. In summary, in normal operation, the air flow is directed into the lower duct 35 at the first end 26 of the body assembly 24 or, in reverse operation, into the upper duct 37 at the first end 26, by the air flow control assembly 101, depending on the mode of operation that is selected.

It will be understood that the system 20 may be utilized to dry the bale bundles on the floor assembly 32 to the preselected target moisture content. However, it will also be understood that the system 20 may alternatively be utilized to increase the moisture content of the bale bundles to the preselected target moisture content, as will be described. For the purposes hereof, it will be understood that in the following description, the system 20 is utilized for drying the bale bundles positioned on the floor assembly 32 (i.e., in normal operation or reverse operation alternately), unless otherwise expressly stated.

As can be seen in FIGS. 1A-1F, body assembly 24 preferably includes a cover subassembly 31 which has ribs 10 that support cover panels 12 therebetween. The cover panels 12 and the ribs 10 define the interior surface 29 that partially defines the interior space 30.

In use, the bale bundles 22 preferably are loaded into the upper portion 36, onto the floor assembly 32 at the second end 28. It will be understood that a number of bale bundles may be loaded into the interior space 30 in series (i.e., one after the other), with each successive bale bundle being pushed on the floor assembly 32 toward the first end 26. As each successive bale bundle is pushed into the interior space, it pushes those previously loaded toward the first end 26, and such loading continues until the floor assembly is covered or substantially covered with the bale bundles positioned thereon. After all the bale bundles 22 that can fit on the floor assembly are loaded therein, a door 39 at the second end 28 preferably is closed (FIG. 1C). Preferably, the door 39 is movable between its closed position (FIG. 1C), and an open position (not shown) in which the bale bundles 22 may be moved into or out of the upper portion 36. Because those skilled in the art would be aware of suitable doors, further description of the door 39 is unnecessary.

Those skilled in the art would be aware of techniques for loading the bale bundles into the subsystem 57, and unloading the bale bundles therefrom. As will be described, in one embodiment, the system 20 may include a “walking floor”, for use in loading and unloading the bale bundles.

It will be understood that the bale bundles 22 are omitted from FIG. 1C and from certain other drawings for clarity of illustration. The bale bundles 22 can be seen in the upper portion 36, supported by the floor assembly 32, in FIGS. 4B, 5A-5F, and 6A-6C.

As noted above, the system 20 preferably is operated to change a moisture content of the bale bundles 22 positioned on the floor assembly 32, consistently throughout the bale bundles 22 to the preselected target moisture content, within an acceptable margin of error. Those skilled in the art would appreciate that, depending on ambient conditions and the crop material, the moisture content of the bale bundles may need to be decreased or increased, as the case may be, in order to change the moisture content to the preselected target moisture content.

For example, if the moisture content is to be lowered in order to reach the preselected target moisture content, then the heater 111 in the fan-heater subassembly 106 (FIGS. 1G, 1H) preferably is energized while the fan is operating, so that the air in the air flow is at a temperature higher than the ambient temperature, to promote evaporation of moisture in the bale bundles. Alternatively, if it is sought to increase the moisture content to the preselected target moisture content, then the air in the air flow may be unheated, or otherwise treated so that the air flow is moisture-bearing.

For instance, moisture may be added to the air in the air flow by a humidifier 159 that may be positioned, e.g., in the fan-heater assembly 106 (FIGS. 1G, 1H). Those skilled in the art would appreciate that the heater 111 preferably is energized when the bale bundles in the subsystem 57 are dried. The humidifier 159 is operated when it is sought to add moisture to the bale bundles.

In one embodiment, if necessary, the air in the air flow may be cooled by a cooling unit (not shown), in order to increase the moisture content to the preselected target moisture content. The cooling unit may be included in the fan-heater assembly 106.

In circumstances where the moisture content of the bale bundles is to be increased to the preselected target moisture content, the system may be operated in normal operation and/or in reverse operation, as may be required in order to achieve a substantially uniform moisture content in the bale bundles.

In use, the system preferably is controlled in order to optimize energy consumption, in the circumstances. For example, if an operator wishes to dry the bale bundles quickly (e.g., for commercial reasons), the air may be heated to a relatively high temperature and the fan may be rotated at a relatively high speed, even though operating in this way may cause relatively high energy consumption. It is believed that, absent unusual requirements, the heater (or cooling unit) and the fan are optimally operated to minimize energy consumption.

Among other factors, the type of forage or crop material, the ambient conditions (temperature and humidity), and energy costs preferably are considered when determining how to optimally operate the system. As an example, where forage to be dried is alfalfa, the air in the air flow may be heated in the fan-heater assembly 106 to approximately 65° C. However, in order to minimize energy inputs into the heat source, the air may instead be heated to a temperature that is only slightly above ambient temperature. Those skilled in the art would appreciate that, where the air is heated to a relatively lower temperature, the fan speed may also be adjusted as required (i.e., increased) to achieve the preselected target moisture content.

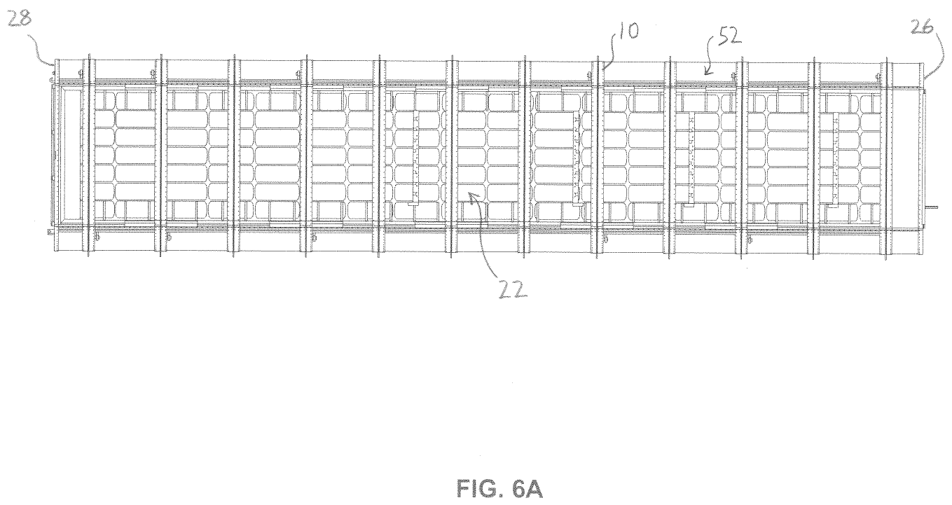

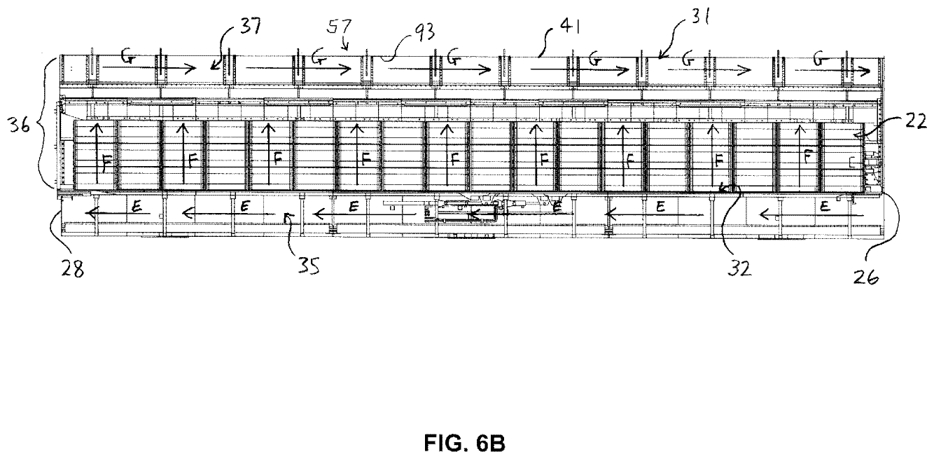

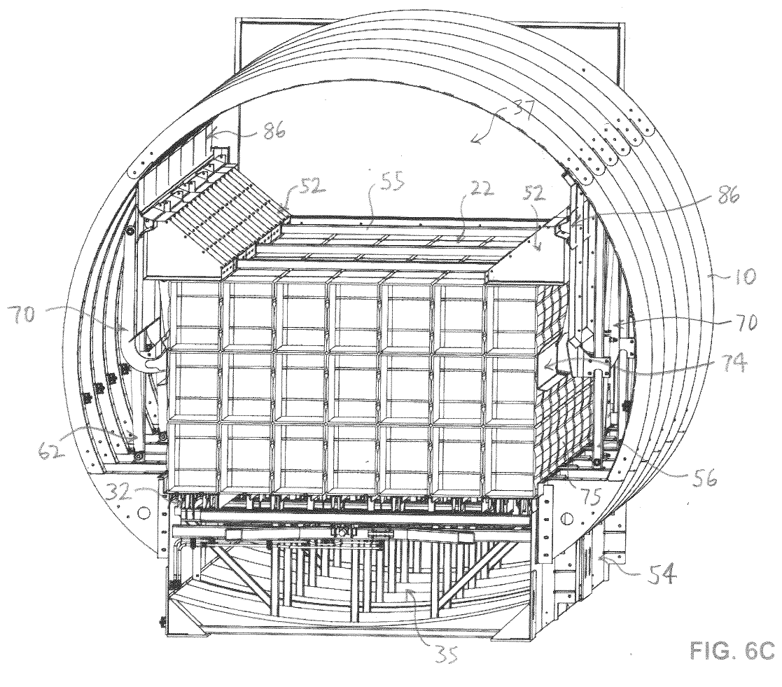

In FIGS. 1C and 6B, the heated air that is directed into the lower duct 35 at the first end 26 is schematically represented by arrows “E”. The interior space 30 is closed at the second end 28 by the door 39. Because the heated air is under a higher pressure than ambient air pressure due to the fan, the heated air in the lower duct 35 moves upwardly into the bale bundles 22 via the openings 34 in the floor assembly 32, and the heated air thereafter moves upwardly through the bale bundles 22 generally toward the upper duct 37. The generally upward movement of the heated air through the bale bundles 22 in this mode of operation (i.e. “normal” operation) is schematically represented by arrows “F” (FIGS. 1C, 6B).

Those skilled in the art would appreciate that the heated air that is directed into the lower duct 35 during normal operation loses heat and is cooled, and also increases its moisture content, as it passes through the bale bundles 22. In the normal mode of operation, the heated air that has moved upwardly into the bale bundles 22 passes through the bale bundles 22, removing moisture therefrom, and into the upper duct 37, through which the air moves toward the first end 26, from which it preferably is at least partially returned to the fan-heater assembly 106, where the air may then be reheated.

Because the air exiting from the upper duct 37 during normal operation has a relatively high moisture content, it may be desirable to allow some of that air to exit to the ambient atmosphere, in order that heated air with a somewhat lower moisture content may be directed into the lower duct 35. For example, the ambient air may have a somewhat lower moisture content, and ambient air may be drawn into the fan-heater assembly 106 via suitable louvers. In this way, the moisture-laden air exiting from the upper duct 37 into the atmosphere may be replaced by relatively drier air from the ambient atmosphere.

As schematically indicated by arrows “F” in FIGS. 1C and 6B, in normal operation, the heated air preferably moves generally upwardly from the lower duct 35 through the bale bundles 22, along the length of the upper portion 36. It will be understood that such generally upward movement of the heated air occurs along the length of the lower duct 35, and through the bale bundles 22 along the length of the floor assembly 32. It will also be understood that, in FIGS. 1C and 6B, the arrows “F” are included in only some of the illustrated bale bundles 22 to simplify the illustrations.

The movement of the cooled air through the upper duct 37 in normal operation is schematically represented by arrows “G” (FIGS. 1C, 6B). At the first end 26, the cooled air moving through the upper duct 37 preferably exits therefrom at the first end 26 to be directed to the fan-heater assembly 106, for recirculation. Preferably, the air is recirculated to the extent feasible, to minimize the energy required to heat the heated air before the air is redirected into the interior space 30.

It will be understood that the ductwork needed for directing the recirculating air flow from the upper duct 37 (and from the lower duct 35, in reverse operation) to the fan-heater assembly 106 is omitted from FIGS. 1G and 1H respectively for clarity of illustration.

In use, in the normal mode of operation, the air flow preferably is directed through the lower duct 35 and then is forced by the door 39 into the upper portion 36. When one or more bale bundles 22 are positioned on the floor assembly 32 (as illustrated in FIGS. 4B, 5A-5F, and 6A-6C) the air flow is directed upwardly through the one or more bale bundles 22 to the upper duct 37, through which the air flow is forced toward the first end 26, at which the air flow exits the body assembly 24.

From the foregoing, it can be seen that, in normal operation mode, the forage or crop material that is in the bale bundles 22 preferably is dried to the preselected target moisture content by the heated air that is directed through the bale bundles 22. Any suitable technique may be used to determine the moisture content of the bale bundles, to determine when the preselected target moisture content has been achieved. In one embodiment, once the preselected target moisture content has been achieved, the fan is de-energized and the bale bundles are removed via the second end 28.

As noted above, the flow of air that in normal operation is directed by the air flow control assembly 101 into the lower duct 35, upwardly through the bale bundles 22 positioned on the floor assembly 32, and exiting via the upper duct 37, may be reversed, in “reverse operation”. In reverse operation mode, the air flow is directed by the air flow control assembly 101 into the upper duct 37 at the first end 26, i.e., in the direction opposite to that indicated by arrows “G” in FIGS. 1C and 6B.

The flow of air in reverse operation mode through the subsystem 57 is illustrated in FIG. 1H. The air flow through the upper duct 37 is indicated by arrows “G₂”. The air flows downwardly through the bale bundles (not shown in FIG. 1H), as indicated by arrows “F₂”. The air flows through the lower duct 37 toward the first end of the subsystem 57, as indicated by arrows “E₂”.

In reverse operation, the air flow is forced downwardly from the upper duct 37 through the bale bundles 22, i.e., in the direction opposite to that indicated by arrows “F” in FIGS. 1C and 6B. The air that is directed through the bale bundles 22 exits therefrom to pass through the openings 34 in the floor assembly 32, and into the lower duct 35. In this embodiment, once the air is in the lower duct 35, it is moved toward the first end 26, i.e., in the direction opposite to that indicated by arrows “E” in FIGS. 1C and 6B. Accordingly, in reverse operation mode, the air flow exits the lower duct 35 at the first end 26. As will be described, the reverse operation air flow exiting the lower duct 35 at the first end 26 preferably is directed to the fan-heater assembly 106 for recirculation thereof.

Reversing the air flow in this way from that of normal operation (i.e., directing heated air into the upper duct 37 at the first end 26, and causing the air flow to exit the lower duct 35 at the first end 26) may be utilized, for example, where normal operation has caused lower regions of the bale bundles 22 to have a somewhat lower moisture content than the preselected target moisture content. In these circumstances (i.e., where normal operation has caused the lower regions of the bale bundles 22 to have relatively low moisture content), upper regions of the bale bundles tend to have correspondingly relatively high moisture content, i.e., higher than the preselected target moisture content.

Operation of the system 20 in its normal mode may cause the lower regions to have a relatively low moisture content because the heated air decreases in temperature and increases in moisture content as it moves upwardly through the bale bundles 22. In the lower region of the bale bundle, the relatively warm air tends to lower the moisture content of the lower region, however, as the air flow moves upwardly through the bale bundle, the air is cooler and has more moisture in it, and hence is less effective at reducing moisture content in the upper region of the bale bundle. As a result, there may be a significant difference in moisture content in the upper and lower regions of the bale bundles.

In reverse operation mode, the heated air flows downwardly from the upper duct 37 into the bale bundles 22, toward the lower duct 35. As the air moves downwardly through the bale bundles 22, the heated air tends to remove moisture from the upper regions. However, because the air cools and increases in moisture content as it moves downwardly through the bale bundles 22, the moisture content of the lower regions of the bale bundles may tend to increase somewhat, if it changes. In this way, the moisture content of the bale bundles may be made generally consistent from upper to lower regions, i.e., preferably at the preselected target moisture content throughout. Preferably, the bale bundles 22 are dried in the system 20 until the moisture content throughout the bale bundles is the preselected target moisture content.

Those skilled in the art would appreciate that the bale bundles 32 may be moved into the upper portion 36 and positioned on the floor assembly 32, and also subsequently removed from the upper portion 36, once the bale bundles 22 have been dried to the preselected target moisture content, using any suitable means. For example, in one embodiment, the floor assembly 32 preferably includes a “walking floor” subassembly “W” (FIG. 1F), which may be used to move each of the bale bundles 22 respectively into the upper portion 36 to position the bale bundles on the floor assembly 32 and until the bale bundles extend between the first and second ends 26, 28 thereon. Walking floors are known, and further description thereof is therefore unnecessary.

Those skilled in the art would appreciate that, utilizing the walking floor, the bale bundles 22 preferably are loaded into the upper portion 36 one at a time, and each successive bale bundle 22 is pushed by the walking floor “W” against the bale bundles that were previously loaded into the upper portion, to push the previously loaded bale bundles toward the first end 26. This process continues until the floor assembly 32 is covered (or substantially covered) with bale bundles 22 from the second end 28 to the first end 26 (as illustrated in FIGS. 4B, 6A, and 6B), at which point the door 39 is closed, and in one embodiment, the heated air preferably is directed into the lower duct 35. When closed, the door 39 provides an airtight seal against the body assembly 24 at the second end 28.

Those skilled in the art would appreciate that, in the absence of the walking floor subassembly, the bale bundles that are loaded into the subsystem 57 tend to be somewhat laterally compressed, due to the pressure exerted laterally on the bale bundles by a forklift as it pushes successive bale bundles toward the first end 26 inside the subsystem 57. There may be several bale bundles loaded into the subsystem, e.g., 18 may be loaded. It has been found that the varying degrees of laterally-directed compaction to which the bale bundles are subjected result in varying degrees of obstruction of air flow through the bale bundles, i.e., at different locations along the length of the loaded bale bundles. In turn, the varying degrees of compaction result in differences in moisture content in the bale bundles after they have been dried over a selected time period. However, when the walking floor subassembly is used to load the bale bundles, the walking floor subassembly limits the extent to which it presses the bale bundles against each other during loading. It is therefore believed that utilizing the walking floor subassembly “W” may promote more consistent moisture reduction throughout the bale bundles.

Once the bale bundles 22 have been loaded into the upper portion 36 on the floor assembly 32, the door 39 (FIG. 1C) is closed. Accordingly, once the bale bundles 22 are loaded onto the floor assembly 32, the lower duct 35 and the upper portion 36 preferably are closed at the second end 28 by the door 39, and the lower duct 35 and the upper portion 36 are in fluid communication with the air flow control assembly 101 at the first end 26 (FIGS. 1G, 1H). It will be understood that, when the system 20 is operating in normal operation or in reverse operation, the air flow may return to the fan-heater assembly 106 via the upper duct 37 or the lower duct 35, as the case may be, through ducts (not shown) located outside the body assembly 24 (FIGS. 1G, 1H).

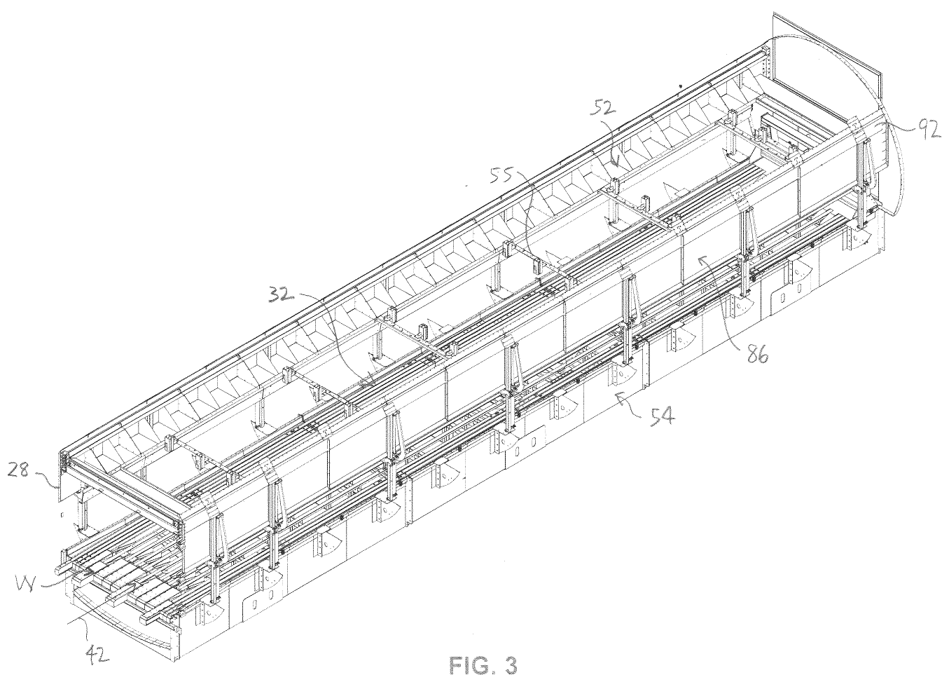

The walking floor subassembly “W” may also be used to move the bale bundles 22 out of the upper portion 36 at the second end 28, once the bale bundles 22 have been dried to the preselected target moisture content. For clarity of illustration, in FIGS. 3 and 4A, the system 20 is shown without any bale bundles 22 therein, and in FIG. 4B, the system 20 is shown with the bale bundles 22 loaded in the upper portion 36, positioned on the floor assembly 32. The direction in which the bale bundles 22 are moved when they are loaded into the upper portion 36 is indicated by arrow 42 in FIGS. 3 and 4A, and the direction in which the bale bundles 22 are moved when they are unloaded from the upper portion 36 is indicated by arrow 44 in FIG. 4B. Once the bale bundles have the preselected target moisture content, the door 39 is opened, and the walking floor subassembly “W” preferably is used to move the bale bundles from the upper portion 36, one at a time.

In summary, in “normal” operation, heated air is directed into the lower duct 35, to decrease the moisture content of the bale bundles 22 positioned on the floor assembly 32. As noted above, the system may be operated in “reverse” operation, in order to cause the moisture content to be the preselected target moisture content substantially throughout the bale bundles 22. As will be described, once the moisture content of the bale bundles is at the preselected target moisture content, the flow of the heated air into the lower duct 35 (or into the upper duct 37, as the case may be) preferably is stopped. At that point, the door 39 is opened, for removal of the bale bundles 22.

Preferably, the body assembly 24 includes a base subassembly 54 in which the lower duct 35 is defined (FIG. 2D). As can be seen in FIGS. 1D-1F, it is preferred that the ribs 10 are attached to the base subassembly 54.

As can be seen in FIGS. 1D and 1F, the floor assembly 32 preferably includes a number of slats 40. Selected ones of the slats 40 are positioned to define the openings 34 therebetween. In one embodiment, the slats 40 preferably are elongate, and arranged parallel to each other. As a result, in the embodiment illustrated, the openings 34 defined between the slats 40 are elongate. However, those skilled in the art would appreciate that the openings 34 may have any suitable size and shape. As noted above, the openings 34 allow heated air from the lower duct 35 to flow upwardly, into the bale bundles 22, during normal operation. It will be understood that, during reverse operation, the openings 34 allow air that is directed downwardly through the bale bundles 22 to exit therefrom into the lower duct 35. As can be seen in FIGS. 3A, 4A, and 4D, it is preferred that the floor assembly 32 defines the openings 34 substantially along the entire length of the upper portion 36 (i.e., between the first and second ends 26, 28), so that all the bale bundles 22 that are positioned on the floor assembly 32 may be dried (or otherwise treated) to have the preselected target moisture content.

As noted above, the engagement assembly 38 is configured for compressing the bale bundles 22 that are positioned on the floor assembly 32. When the bale bundles 22 are sufficiently compressed, the bales inside the respective bale bundles 22 are urged against each other, thereby minimizing the risk of gaps inside the bale bundles between the bales through which air may easily pass, and thereby promoting more uniform drying of the bale bundles 22.

It is believed that, in the absence of the partial compression of the bale bundles by the engagement assembly 38, when heated air is directed through the bale bundles, the bale bundles will not be dried consistently throughout because the heated air would tend to flow through channels between the bales in the bale bundles.

In one embodiment, the engagement assembly 38 preferably includes an upper subassembly 46 that includes left and right flap elements 52 positioned proximal to the left and right sides “LS”, “RS” of the body assembly 24 respectively. The left and right flap elements 52 are configured for engaging one or more selected portions of a top side 88 of the bale bundle 22 positioned on the floor assembly 32 (FIGS. 5A, 5E).

It will be understood that one or both of the flap elements may be collectively or individually identified hereinafter by reference character 52. For clarity of illustration, the left and right flap elements are identified by reference characters L52 and R52 respectively in FIGS. 1D, 1E, and 5F.

The engagement assembly 38 preferably also includes an intermediate subassembly 48 for supporting the upper subassembly 46.

The intermediate subassembly 48 preferably is also configured for moving the upper subassembly between raised and lowered positions thereof. The engagement assembly 38 is in a disengaged condition thereof when the upper subassembly 46 is in the raised position (FIG. 5A), and the engagement assembly 38 is in an engaged condition thereof, for engagement with the bale bundles positioned on the floor assembly, when the upper subassembly 46 is in the lowered position thereof (FIG. 5E).

The engagement assembly 38 preferably also includes a support subassembly 50 for at least partially supporting the upper subassembly 46 and the intermediate subassembly 48 (FIG. 2D).

The support subassembly 50 includes left and right side panels 86 located between the left and right sides “LS”, “RS” of the body assembly 24 and the left and right flap elements 52 respectively (FIG. 5A). The side panels 86 extend between the first and second ends 26, 28. The side panels 86 have respective internal sides 85 thereof that are configured to be located proximal to respective left and right sides 75 of the bale bundles 22, when the bale bundles are positioned on the floor assembly 32 (FIGS. 1D, 2D).

When the bale bundles are positioned on the floor assembly and the engagement assembly 38 is in the engaged condition, the left flap element and the left side panel 86 define a left gap 102 therebetween, and the right flap element and the right side panel 86 define a right gap 102 therebetween (FIG. 5F).

The upper subassembly 46 additionally includes one or more left side seal subassemblies 103 configured for sealing the left gap 102 and one or more right side seal subassemblies 103 configured for sealing the right gap 102, to at least impede air flowing through the left and right gaps 102 respectively (FIG. 5F). Preferably, the side seal assemblies 103 prevent, or substantially prevent, air from flowing through the gaps 102 (FIG. 5G).

It will be understood that, to accommodate the bale bundles when they are moved into the upper portion 36 and onto the floor assembly 32, the engagement assembly 38 is in a disengaged condition thereof when the bale bundles 22 are first loaded into the upper portion 36 (FIG. 5A). Preferably, the engagement assembly 38 is in its disengaged condition at that point so that the bale bundles 22 may relatively easily be loaded into the upper portion 36 onto the floor assembly, as described above, e.g., by utilizing the walking floor “W”. As noted above, during loading, previously loaded bale bundles preferably are, one at a time, successively pushed along the floor assembly 32 toward the first end 26 by the subsequently individually loaded bale bundles, until the first loaded bale bundles 22 have been pushed to the first end 26, and further bale bundles cannot be loaded into the upper portion 36.

Once a sufficient number of the bale bundles 22 have been loaded onto the floor assembly 32 to cover the floor assembly 32 between the first and second ends 26, 28, the engagement assembly 38 preferably is moved from its disengaged condition (FIG. 5A) to an engaged condition thereof (FIGS. 5E, 5F). As noted above, when the engagement assembly 38 is in its engaged condition, the engagement assembly 38 at least partially compresses the bale bundles 22 that are positioned on the floor assembly 32. Specifically, the bale bundles are partially compressed between the flap elements 52 and the floor assembly 32.

When the engagement assembly 38 is in its engaged condition and partially compressing the bale bundles 22, in normal operation, heated air is initially directed into the lower duct 35, and then upwardly through the bale bundles and into the upper duct 37, as schematically represented by arrows “Z₁”-“Z₄” in FIG. 5F. In normal operation, the air flow preferably exits the upper duct 37 at the first end 26 and is channelled by ducts (not shown) into an upstream end 118 of the fan-heater assembly 106, for recirculation of the air (FIG. 1G).

In FIG. 1G, the air flowing from the upper duct 37 to the upstream end 118 for recirculation thereof is schematically represented by arrows “NR-1”, “NR-2”, “NR-3”, and “NR-4”.

As noted above, because the air exiting from the upper duct 37 during normal operation (the “normal return air”) has a relatively high moisture content, it is preferred that a portion of the normal return air be released into the ambient atmosphere, and to replace such portion, fresh air is drawn into the fan-heater assembly 106. In FIG. 1G, the portion of the normal return air that is released into the ambient atmosphere is schematically represented by arrow “NL”, and the fresh air drawn into the fan-heater assembly 106 is schematically represented by arrow “LN”.

As can be seen in FIG. 1G, in normal operation, the air flow generated by the fan 104 through the air flow control assembly 101 is schematically represented by arrows “S₁”, “S₂”. Such air flow is directed by the air flow control door 116 into the lower duct 35 (FIG. 1G). As noted above, the air flow through the lower duct 35, upwardly through the bale bundles (not shown in FIG. 1G) positioned on the floor assembly 32 and through the upper duct 37 is schematically represented by arrows “E”, “F”, and “G”, as shown in FIG. 1C.

Alternatively, the system 20 may be operated in the reverse mode. When in reverse mode, the heated air is initially directed into the upper duct 37, and then downwardly through the bale bundles 22, i.e., in directions opposite to the directions of the arrows “Z₁”-“Z₄” in FIG. 5F, into the lower duct 35. In the reverse mode, the air exits the lower duct 35 at the first end 26 and is channelled by ducts (not shown) into the upstream end 118 of the fan-heater assembly 106, for recirculation of the air (FIG. 1H). In FIG. 1H, the air flowing from the lower duct 35 to the upstream end 118 for recirculation thereof is schematically represented by arrows “RR-1”, “RR-2”, “RR-3”, and “RR-4”.

As noted above, because the air exiting from the lower duct 35 during reverse operation (the “reverse return air”) has a relatively high moisture content, it is preferred that a portion of the reverse return air be released into the ambient atmosphere, and to replace such portion, fresh air is drawn into the fan-heater assembly 106. In FIG. 1H, the portion of the normal return air that is released into the ambient atmosphere is schematically represented by arrow “RL”, and the fresh air drawn into the fan-heater assembly 106 is schematically represented by arrow “LR”.

As can be seen in FIG. 1H, in reverse operation, the air flow generated by the fan 104 through the air flow control assembly 101 is schematically represented by arrows “M₁”-“M₄”. Such air flow is directed by the air flow control door 116 into the upper duct 37 (FIG. 1H). As noted above, the air flow through the upper duct 37, downwardly through the bale bundles (not shown in FIG. 1H) positioned on the floor assembly 32 and through the lower duct 35 is schematically represented by arrows “G₂”, “F₂”, and “E₂”, respectively.

It will be understood that the engagement assembly 38 is shown in a series of intermediate conditions thereof in FIGS. 5B-5D in which the engagement assembly 38 is shown progressing from the fully disengaged condition of FIG. 5A to the fully engaged condition of FIG. 5E.

Preferably, the flap elements 52 include engagement surfaces 53 that are formed for engagement with selected portions of top sides 88 of the bale bundles 22 positioned on the floor assembly 32 (FIGS. 2D, 5E). As can be seen in FIG. 2D, the flap elements 52 and the engagement surfaces 53 thereof preferably are positioned along both sides of the body assembly 24 to extend between the first and second ends 26, 28. Accordingly, when the engagement assembly 38 is in the engaged condition thereof, the engagement assembly at least partially compresses all of the bale bundles 22 positioned on the floor assembly 32 against the floor assembly (FIGS. 2A, 2D, 5E, 5F).

Those skilled in the art would appreciate that, because the flap elements engage only selected portions of the top sides 88 of the bale bundles, the compression effected by the engagement assembly 38 is primarily achieved in the parts of the bale bundles that are directly below such selected portions. Also, because only the selected portions of the top sides 88 are covered by the engagement surfaces 53 of the flap elements 52, the air is allowed to flow through the bale bundles vertically with only minimal obstruction thereto by the engagement surfaces 53 (FIG. 5F).

As can be seen in FIGS. 1D, 1E, 2D and 4A, the upper subassembly 46 preferably also includes a member of cross-members 55 that connect the left and right hand side flap elements 52. It will be understood that the air flow is permitted to pass between the respective cross-members 55 and through the one or more bale bundles 22 on the floor assembly 32 when the engagement assembly 38 is in the engaged condition (FIG. 5F).

The support subassembly 50 preferably includes a number of post elements 56 (FIGS. 2A-2D). Each of the post elements 56 extends between a top end 58 and a bottom end 60 (FIG. 1D). In one embodiment, as can be seen in FIG. 1D, the top end 58 preferably is secured to a rib 10, and the bottom end 60 preferably is secured to the base subassembly 54, directly or indirectly.

The intermediate subassembly 48 preferably connects the support subassembly 50 and the upper subassembly 46.

Preferably, each of the post elements 56 partially supports a moving element 62. The moving element 62 preferably is also included in the intermediate subassembly 48. In one embodiment, for example, the moving element 62 preferably is a hydraulic cylinder. Those skilled in the art would be aware of other suitable moving elements 62, e.g., electric motors. The moving element 62 extends between upper and lower ends 63, 65 thereof (FIG. 2B). In one embodiment, the moving element 62 has a top end 64 that is movable relative to a bottom end 66, between an extended position (FIG. 5A) and a retracted position (FIG. 5E) of the moving element 62.

As will be described, when the top end 64 is at its extended position, the engagement assembly 38 is in its fully disengaged condition (FIG. 5A). When the top end 64 is at its fully retracted position, the engagement assembly 38 is in its fully engaged condition (FIG. 5E).

It will be understood that the system 20 includes a number of moving elements 62 and post elements 56, spaced apart, positioned along the length of the body assembly 24 between the first and second ends 26, 28.

From the foregoing, it can be seen that the engagement assembly 38 (i.e., extending lengthwise between the first and second ends 26, 28) moves between the fully disengaged and fully engaged conditions thereof (FIGS. 5A-5E). In order for this to take place, the moving elements 62 are activated, so that the top ends 64 of all the moving elements 62 preferably move in unison, or substantially in unison, to move the engagement assembly 38 between its engaged and disengaged conditions. Those skilled in the art would be aware of controls that may be utilized to cause the top ends 64 of all the moving elements 62 of the engagement assembly 38 to move in unison, i.e., between the extended and retracted positions thereof.

As can be seen in FIG. 2B, the moving element 62 preferably is pivotably connected with the post element 56 at the lower end 65 of the moving element 62 by a lower pivot pin connection 68. The intermediate subassembly 48 of the engagement assembly 38 preferably includes a linkage arm 70 with a first portion 71. It is preferred also that the moving element 62 is pivotably connected with the first portion 71 at the upper end 63 of the moving element 62 by an upper pivot pin connection 72 (FIGS. 2B, 2C).

Preferably, the intermediate subassembly 48 of the engagement assembly 38 also includes side bars 74 positionable for engaging the respective left and right sides 75 of the bale bundles (FIGS. 2B, 5A). As can be seen in FIGS. 5A-5F, the two side bars 74 are positioned on opposite (left and right) sides of the one or more bale bundles 22. It will be understood that the side bars extend substantially between the first end 26 and the second end 28.

Only one side of the engagement assembly 38, i.e., the right side thereof, will now be described in detail. It will be understood that the left side of the engagement assembly 38 is the mirror image of the right side thereof. As can be seen in FIG. 2B, it is preferred that the first portion 71 of the linkage arm 70 extends between upper and lower ends 76, 78 thereof. At the upper end 76, the linkage arm 70 is pivotably connected with the moving element 62, via the upper pivot pin connection 72 (FIG. 2B). At the lower end 78, the linkage arm 70 preferably is connected with the side bar 74.

As will be described, each side bar 74 is pivotable between a first position thereof (FIG. 5A), in which the side bar 74 is positioned distal to (and disengaged from) the side 75 of the bale bundles 22, and a second position thereof (FIGS. 5E, 5F), in which the side bar 74 is urged against the side 75 of the bale bundles and is engaged therewith. It can be seen in FIGS. 5A-5E that the side bar 74 on the left side of the engagement assembly 38 also moves between a disengaged position (FIG. 5A) when the upper subassembly 46 is in its raised position, and an engaged position (FIGS. 5E, 5F), when the upper subassembly 46 is in its lowered position.

The linkage arm 70 preferably also includes a second portion 79. As can be seen, e.g., in FIG. 2C, the two portions 71, 79 of the linkage arm 70 meet at respective lower ends 78, 80 thereof, so that the linkage arm 70 is a generally U-shaped element. It is preferred that the second portion 79 is pivotably connected at its upper end 81, by a pivot pin connection 82, with an internal post 84 mounted proximal to the internal side of the side panel (FIGS. 2C, 2D, 2E).

As noted above, the system 20 includes respective side panels 86 proximal to the left and right sides of the body assembly 24 (FIGS. 1D, 1F, 2A, 2C). It will be understood that the side panels 86 and the post elements 56 are included in the support subassembly 50 of the engagement assembly 48 (FIG. 2D). It will also be understood that the side panels 86 are stationary relative to the body assembly 24, and extend along each side of the body assembly, generally between the first and second ends 26, 28 (FIGS. 2A, 2C, 2D, 3, 6C).

The side panels 86 may be secured in place by any suitable means. For example, it is preferred that the side panels include one or more flanges 92 (FIGS. 2C, 2D, 3, 4A, 4B) that are secured to internal surfaces 93 of the cover panels 12 (FIGS. 1B, 1C, 6B).

As can be seen in FIG. 2E, the internal post 84 supports the upper subassembly 46, and is secured thereto. (It will be understood that the flap element and part of the side panel are omitted from FIG. 2E for clarity of illustration.)

The flap elements 52 preferably are supported by the internal posts 84 (FIG. 1D). As noted above, the linkage arm 70 is pivotably connected to the internal post 84 via the second portion 79 thereof and the pivot pin connection 82 (FIG. 4E). Accordingly, upward or downward movement of the top end 64 of the moving element 62 causes corresponding upward or downward movement of the internal post 84 respectively, which in turn causes corresponding upward or downward movement of the upper subassembly 46, i.e., corresponding upward or downward movement of the flap elements 52 thereof (FIGS. 1D, 2E, 4E, 5A-5E).

It will be understood that a post element 56 that is associated with the linkage arm 70 is omitted from FIG. 2E for clarity of illustration. A post element that is operably connected to another moving element (identified by reference character 62′ in FIG. 2E) is identified for convenience in FIG. 2E by reference character 56′.

As can also be seen in FIGS. 2E and 4E, a lower end 94 of the internal post 84 is supported by a sliding bracket 96 that is slidably mounted to the adjacent post element 56. It will be understood that an upper end 98 of the internal post 84 is secured to the upper subassembly 46 of the engagement assembly 38, at the flap elements (FIGS. 2E, 5A).

As can be seen, e.g., in FIGS. 2E and 5A, due to the linkage arms 70, downward movement of the top ends 64 causes corresponding downward movement of the upper subassembly, until the flap elements 52 engage the top sides 88 of the bale bundles 22. From the foregoing, it can be seen that each side bar 74 is mounted to a linkage arm 70, and is movable relative to the side panels 86. The engagement assembly 38 is configured so that when the upper subassembly 46 is moving downwardly, the side bar 74 does not move until after the flap elements 52 engage the top sides 88, or shortly thereafter.

In FIG. 5A, the engagement assembly 38 is shown in its disengaged condition, and the engagement assembly 38 is shown in its engaged condition in FIG. 5E. It will be understood that, in FIGS. 5A-5E, the engagement assembly 38 is shown moving from the fully disengaged condition thereof through successive intermediate conditions to the fully engaged condition thereof, in the successive views. The downward movement of the upper subassembly 46 relative to the support subassembly 50 (i.e., movement from disengaged to engaged conditions) is effected by simultaneous downward movement of the top ends 64 of the moving elements 62, as described above (FIG. 2E).

For convenience, the engagement assembly 38 is shown in three successive intermediate conditions in FIGS. 5B, 5C, and 5D. A first intermediate condition, in which the engagement assembly 38 has started to move from its disengaged condition (FIG. 5A) to its engaged condition (FIG. 5E), is illustrated in FIG. 5B. Next, in FIG. 5C, the engagement assembly 38 is shown having moved closer to the engaged condition, and in this view the engagement assembly 38 is in a second intermediate condition. In FIG. 5D, the engagement assembly 38 is shown in a third intermediate condition, in which the engagement assembly 38 has moved still closer to its engaged condition, relative to its condition as illustrated in FIG. 5C.

Similarly, when FIGS. 5E-5A are considered in reverse order, i.e., from FIGS. 5E to 5A successively, it can be seen that the engagement assembly 38 may move from its fully engaged condition to its fully disengaged condition, e.g., after the bale bundles 22 have been dried to the preselected target moisture content, prior to removal thereof from the upper portion 36. It will be understood that the movement of the upper subassembly 46 upwardly relative to the support subassembly 50 (i.e., movement from engaged to disengaged conditions) is effected by simultaneous upward movement of the top ends 64 of the moving elements 62 (FIG. 2E).

In the following description, only the movements of the elements on one side of the engagement assembly 38 (the left side) are described in detail, to simplify the description. It will be understood that the corresponding elements on the right side of the engagement assembly move in the same way as those described, in a mirror image thereof.

When the engagement assembly 38 is in its disengaged condition (FIG. 5A), the top ends 64 of the moving elements 62 (FIG. 2E) are all in their uppermost extended positions, i.e., they are extended to the greatest extent possible. As can be seen in FIG. 5A, when the engagement assembly 38 is in its disengaged condition, the engagement surfaces 53 (FIG. 2D) of the flap elements 52 are disengaged from the bale bundles 22. Specifically, the engagement surfaces 53 are held above the top sides 88 of the bale bundles 22, spaced apart from the top sides 88 by a predetermined vertical distance “H” (FIG. 5A). Also, when the engagement assembly 38 is in its disengaged condition, each side bar 74 is positioned at the first position thereof, i.e., each side bar 74 is positioned as far away from the sides 75 as can be permitted by the linkage arm 70, to which each side bar 74 is secured respectively.

Preferably, the distance “H” is sufficiently large to permit the bale bundles 22 to be easily moved in or out of the interior space 30 on the floor assembly without the bale bundles engaging the flap elements 52.

In order to move the engagement assembly 38 from its disengaged condition to its engaged condition, the top ends 64 move downwardly, so that the upper ends 63 of the moving elements 62 are moved toward the lower ends 65 thereof. As noted above, it is preferred that the top ends 64 of the moving elements 62 positioned along the body, on both sides thereof, move downwardly in unison, or substantially in unison. As a result, the flap elements 52 at the left and right sides are then vertically moved in unison, or substantially in unison (FIGS. 2E, 5A).

As can be seen in FIG. 5A, the upper end 76 of the first portion 71 of the linkage arm 70 is pivotably connected to the top end 64 of the moving element 62, at the upper pivot pin connection 72. The upper end 81 of the second portion 79 is pivotably connected to the internal post 84 at the pivot pin connection 82 (FIGS. 2E, 5A).

From the foregoing, it can be seen in FIGS. 2E and 5A that, until the flap elements 52 engage the top sides 88 of the bale bundles 22, movement of the top end 64 downwardly (i.e., in the direction indicated by arrow “X₁” in FIG. 5A) causes corresponding movement downwardly of the upper end 76, and also corresponding downward movement (at the same rate) of the upper end 81 of the second portion 79 of the linkage arm 70. As can be seen, e.g., in FIGS. 2E and 5B, until the flap elements 52 engage the top sides 88, downward movement of the upper end 81 of the second portion 79 causes corresponding (i.e., equal) downward movement of the internal post 84, and therefore also corresponding and equal downward movement of the upper subassembly 46.

Accordingly, to move the engagement assembly 38 from its disengaged condition (FIG. 5A) to the first intermediate condition (FIG. 5B), the top ends 64 of the moving elements 62 are moved downwardly, i.e., in the direction indicate by arrow “X₁” in FIG. 5A. As can be seen in FIG. 5B, in the first intermediate condition, the vertical distance between the surfaces 53 and the top sides 88 of the bale bundles 22 is less than the distance “H”. Because the engagement surfaces 53 have not engaged the top sides 88 (as illustrated in FIG. 5B), the top end 64 (and the upper end 76) and the upper end 81 of the second portion 79 move downwardly together, i.e., at the same rate. As a result, the side bar 74 remains in its first position when the engagement assembly 38 is in its first intermediate condition (FIG. 5B).

In order to move the engagement assembly 38 to the second intermediate condition, the top ends 64 are moved further downwardly, as indicated by arrow “X₂” in FIG. 5B. In the second intermediate condition, illustrated in FIG. 5C, the engagement surfaces 53 are engaged with the top sides 88 of the bale bundles 22, however, at this point, the engagement surfaces 53 are not urged against the top sides 88. It will be understood that, in FIG. 5C, the engagement surfaces 53 are merely touching the top sides 88, but do not apply any pressure to the top sides 88. Accordingly, as illustrated in FIG. 5C, the side bar 74 remains in its first position when the engagement assembly 38 is in its second intermediate condition.

As a result, in each of FIGS. 5A-5C, the side bars 74 remain in their first position (i.e., disengaged from the sides 75 of the bale bundles 22), even though the flap elements 52 have moved downwardly in the circumstances illustrated successively in FIGS. 5A-5C.

In FIG. 5D, the engagement assembly 38 is shown in the third intermediate condition, due to further downward movement of the top ends 64, as indicated by arrow “X₃” in FIG. 5C. As can be seen in FIG. 5D, as illustrated, due to continued downward travel of the top ends 64, the surfaces 53 are urged downwardly against the top sides 88 of the bale bundles 22. As will be described, this causes the side bar 74 to be moved from its first position and toward its second position (FIG. 5D). In this intermediate condition, the side bars 74 do not engage the sides 75 of the bale bundles. In order to move the engagement assembly 38 to its fully engaged condition, the top ends 64 of the moving elements 62 are moved further downwardly, as indicated by arrow “X₄” in FIG. 5D.

In FIG. 5E, the engagement assembly 38 is shown in its fully engaged condition, in which the surfaces 53 are urged against the top sides 88 of the bale bundles 22, and the side bar 74 is in a second position thereof, in which the side bars 74 are urged against the sides 75 of the bale bundles 22. It will be understood that, when the engagement assembly 38 is in its fully engaged condition, the top ends 64 are continually urged downwardly (i.e., in the direction indicated by arrow “X₅” in FIG. 5E).

As noted above, the upper end 76 of the first portion 71 of the linkage arm 70 is pivotably connected to the top end 64 of the moving element 62. The upper end 76 therefore moves with the top end 64 of the moving element 62. The upper end 81 of the second portion 79 is pivotably connected to the internal post 84, which is in a fixed relationship with the flap element 52 (FIGS. 2E, 4E). In FIGS. 5A-5C, downward movement of the top end 64 causes corresponding downward movement of the flap element 52. As a result, in the different circumstances illustrated in FIGS. 5A-5C, the upper ends 76, 81 of the two portions 71, 79 of the linkage arm 70 move downwardly together, i.e., at the same rate (FIGS. 2D, 5A-5C).

However, when the flap element engagement surfaces 53 engage the top sides 88, and are urged downwardly against the top sides 88 (as shown in FIGS. 5D and 5E), although the top end 64 continues to travel downwardly, the upper end 81 of the second portion 79 does not travel downwardly at the same rate as the top end 64. Although the top ends 64 move downwardly at this point, corresponding equal downward movement of the upper subassembly 46 is not possible, because the flap elements 52 are engaged at this point with the top sides 88.

It is believed that, once the engagement surfaces 53 engage the top sides 88, the flap elements 52 would in most cases only travel an insignificant further distance downwardly thereafter. After initial engagement, the flap elements 52 compress the bale bundles 22 due to continued downward movement of the top ends 64.

As a result of the top end 64 (and the upper end 76 of the first portion 71) continuing to move downwardly while the upper end 81 of the second portion 79 is substantially stationary, the linkage arm 70 is pivoted inwardly, moving the side bars 74 from their first position toward the sides 75 of the bale bundles 22 (i.e., toward its second position), pivoting substantially about the pivot pin connection 82. Such pivoting movement on the left side is schematically represented by arrow “Y₁” in FIG. 5D.

Referring to FIGS. 2E and 5E, it can be seen that further downward movement of the top end 64 while the upper end 81 of the second portion 79 is substantially stationary causes the linkage arm 70 to pivot further inwardly about the pivot pin connection 82, moving the side bars 74 to their second position, in which the side bars 74 are urged against the sides 75 of the bale bundles 22. Such further pivoting movement on the left side is schematically represented in FIG. 5E by arrow “Y₂”.

As can be seen in FIGS. 5D and 5E, the arrows “Y₁”, “Y₂” are drawn to show pivoting movement of the linkage arm 70 that is positioned on the left-hand side of the engagement assembly 38, as illustrated in FIGS. 5D and 5E. It will be understood that the linkage arm 70 and elements connected therewith that are positioned on the right-hand side of the engagement assembly 38 (as illustrated in FIGS. 5A-5E) are subject to the same movement as the corresponding elements thereof on the left-hand side of the engagement assembly 38, in mirror images thereof. So, for example, in FIG. 5D, the linkage element 70 on the right-hand side as illustrated pivots in a clockwise direction pivoting movement that is the mirror image of the counterclockwise movement of the linkage element 70 in a counter-clockwise direction (indicated by arrow “Y₁”). Similarly, in FIG. 5E, the linkage element 70 on the right-hand side pivots further in a clockwise direction pivoting movement that is the mirror image of the counterclockwise movement of the linkage element 70 in a counter-clockwise direction (indicated by arrow “Y₂”).

In summary, the intermediate subassembly 48 includes left and right side bars 74, that are configured for engagement with the left and right sides 75 respectively of the bale bundles 22 positioned on the floor assembly when the engagement assembly 38 is in the engaged condition thereof (FIGS. 2D, 4E, 5E, 5F).

Also, as noted above, the intermediate subassembly 48 is configured for initial engagement of the side bars 74 with the left and right sides 75 of the bale bundles 22 as the upper subassembly 46 moves from the raised position thereof to the lowered position thereof when the flap elements 52 engage the one or more selected portions of the top side 88 of the bale bundles positioned on the floor assembly 32. As will be described, when the upper subassembly 46 is moved from the lowered position thereof to the raised position thereof, the flap elements 52 disengage from the one or more selected portions of the top sides 88 of the bale bundles, releasing the bale bundles. At that point, the bale bundles may be removed from the floor assembly 32.

Once the engagement assembly 38 is in its fully engaged condition (FIG. 5E), in which the bale bundles 22 are compressed by the flap elements 52 and by the side bars 74, and with the door 39 closed, in normal operation, the heated air is directed into the lower duct 35 in order to reduce the moisture content of the bale bundle 22, as described above.

The bale bundles 22 preferably are positioned on the floor assembly 32 and, in normal operation, the heated air is directed into the lower duct 35 until the bale bundles 22 have the preselected target moisture content. (It will be understood that operating the system 20 in reverse operation may be utilized, if necessary, to achieve the preselected target moisture content throughout the bale bundles.) As noted above, due to the compression of the bale bundles 22 by the engagement assembly 38 when it is in its engaged condition, gaps between the bales in the respective bale bundles are eliminated (or substantially eliminated), preferably resulting in the bale bundles 22 being dried substantially uniformly to the preselected target moisture content throughout.

As noted above, one or more moisture measurement devices 114 are schematically illustrated in FIGS. 1G and 1H. Those skilled in the art would appreciate that there are various means that may be used to determine the moisture content of the bale bundles. Those skilled in the art would also be aware of such means. For instance, a number of moisture-sensing probes may be inserted into the bale bundles, spaced apart from each other along the length of the subsystem 57 in order to measure moisture content throughout the bale bundles.

The measured moisture content may be transmitted to a processor, which may be included in the controller 113. Also, the measured moisture content may be displayed in any convenient manner, in real time (i.e., substantially instantaneously), to enable an operator (not shown) to assess the status of the treatment of the bale bundles.

The processor may be used to compare the measured moisture content to the preselected target moisture content. Those skilled in the art would appreciate that the controller 113 may be configured to take appropriate action, depending on the differences between the measured moisture content and the preselected target moisture content. It will be understood that the controller 113 may function automatically, and may also permit manual override. In one embodiment, upon the measured moisture content being at the preselected target moisture content, the controller 113 may generate one or more suitable signals, to alert the operator accordingly.

As noted above, following operation in the normal mode, lower regions of the bale bundles may have relatively low moisture content, and upper regions may have relatively higher moisture content. The system may then be operated in reverse mode for a time, in order to produce more uniform moisture content throughout the bale bundles.

When the bale bundles 22 are at the preselected target moisture content, the engagement assembly 38 preferably is moved from its engaged condition (shown in FIG. 5E) to its disengaged condition (shown in FIG. 5A). It will be understood that the steps illustrated in FIGS. 5A-5E are reversed, in order to move the engagement assembly 38 to the disengaged condition.

For instance, in order to move the engagement assembly 38 toward the disengaged condition from the engaged condition, the top end 64 (FIG. 2E) is moved upwardly, i.e., in a direction opposite to the direction indicated by arrow “X₅” in FIG. 5E. It will be understood that, as the top end 64 moves upwardly, because the engagement surfaces 53 (FIG. 2D) remain briefly engaged with the top sides 88 when the top end 64 initially starts rising, the linkage arm 70 pivots outwardly, i.e., in a direction opposite to that indicated by arrows “Y₁”, “Y₂”, causing the side bar 74 to be moved from its second position toward its first position, as shown in FIG. 5D.

Preferably, the upward movement of the top end 64, in the direction opposite to arrows “X₄”, “X₃”, “X₂”, and “X₁” in each of FIGS. 5D, 5C, 5B, and 5A successively, continues until the engagement assembly 38 is in the disengaged condition, illustrated in FIG. 5A. In FIG. 5C, the point at which both the upper end 81 of the second portion 79 and the top end 64 are able to move upwardly together (i.e., at the same rate) is illustrated, and at that point, the linkage arm 70 has pivoted outwardly to the extent that the side bar 74 is in the first position. When the upper end 81 of the second portion 79 moves upwardly, it causes corresponding upward movement of the upper subassembly 46 (FIG. 2E). It will be understood that upward movement of the top ends 64 causes corresponding upward movement of the upper assembly 46 only after the flap element engagement surfaces 53 are disengaged from the top sides 88.

It will also be understood that, as shown successively in FIGS. 5B and 5A, as the top end 64 rises further, the upper end 81 also is raised, at the same rate as the top end 64. As a result, the upward movement of the upper subassembly 46 from the situation illustrated in FIG. 5B to the situation illustrated in FIG. 5A does not result in further pivoting movement of the linkage arm 70.

Preferably, when the engagement assembly 38 is in the disengaged condition, the door 39 is opened, and the bale bundles 22 may be removed from the upper portion 36.

As can be seen in FIG. 5F, when the bale bundles 22 are located on the floor assembly 32 and the engagement assembly 38 is in its engaged condition, in normal operation, the heated air moves generally upwardly through the bale bundles 22. As illustrated in FIG. 5F, when the engagement assembly 38 is fully engaged with the bale bundles 22, the upward flow of the heated air (schematically indicated by arrows “Z₂” and “Z₃”) is generally unimpeded by the engagement assembly 38.

However, because the flap engagement surfaces 53 are engaged with the top sides 88 of the bale bundles 22 at locations thereon proximal to the sides 75, air that is directed upwardly (in normal operation) at or adjacent to the sides 75 of the bale bundles 22 is unable to exit from the bale bundles 22 directly upwardly, at the top sides 88 near the sides 75 of the bale bundles 22. Due to such obstruction of upward air flow exiting the bale bundles 22 proximal to the sides 75, the upward air flow proximal to the sides 75 is diverted slightly inwardly before exiting via the top side 88, as schematically illustrated by arrows “Z₁”, “Z₄”.

As noted above, the upper subassembly 46 preferably includes respective side seal subassemblies 103 that are located proximal to the panels 86 at the left and right sides of the body assembly 24. The side seal subassemblies 103 provide airtight (or substantially airtight) seals of respective gaps 102 between the side panels 86 and the left and right flap elements 52. Due to the side seal subassemblies 103, the air that is directed upwardly at the sides 75 is forced to move through the bale bundles 22 and to exit therefrom via the upper side 88 of the bale bundles 22.

As can be seen in FIG. 5G, when the engagement assembly 38 moves between its disengaged and engaged conditions, the flap elements 52 move vertically relative to the side panels 86 adjacent thereto. As noted above, when the engagement assembly 38 is in its engaged condition, the gap 102 is defined between the flap element 52 and the adjacent side panel 86, in order to permit vertical movement of the flap element 52 relative to the adjacent side panel 86. In FIG. 5G, the flap element 52 proximal to the right side “RS” of the body assembly and parts of the side panel 86 adjacent thereto are shown, at a larger scale, in order to illustrate the side seal subassembly 103 in detail. It will be understood that the side seal subassembly 103 that is proximal to the left side “LS” of the body assembly is the mirror image of the side seal assembly 103 that is proximal to the right side “RS”. In FIG. 5G, the gap 102 is defined between an outer edge “Q” of the flap element 52, and an inner edge “R” of the side panel 86. The side seal subassembly 103 is provided to prevent (or to substantially prevent) the air flow from travelling upwardly, through the gap 102, when the system 20 is operated in its normal mode. The side seal subassembly 103 also is provided to prevent (or to substantially prevent) the air flow from travelling downwardly, through the gap 102, when the system is operated in its reverse mode.

The two seal subassemblies 103 that are provided (i.e., one on each of the left and right sides) each extend along the respective sides of the body assembly 24, between the first and second ends 26, 28.

In the embodiment illustrated in FIG. 5G, the seal subassembly 103 preferably includes a number of flexible vanes, which are identified in FIG. 5G by reference characters 105A-105D for convenience. In FIG. 5G, upper and lower portions 52_{U}, 52_{L} of the flap element 52 are identified. As can be seen in FIG. 5G, the seal subassembly 103 preferably also includes a bracket 106 that is mounted to the upper portion 52u.

In one embodiment, each of the flexible vanes 105A-105D preferably extends between inner and outer ends 107, 108 thereof. (For convenience, only the inner and outer ends 107, 108 of the vane 105C are identified.) The seal subassembly 103 preferably also includes respective sleeve elements 109, for holding the inner ends of the respective vanes 105A-105D in predetermined positions relative to the side panel 86.

Preferably, the sleeve elements 109 are mounted to the bracket 106. The sleeve element 109 is formed to extend beyond the outer end “Q” of the flap element 52 to allow the outer end 108 of the vane to engage the inner side “R” of the side panel 86, before, during, and after movement of the flap element 52 (i.e., upwardly or downwardly) relative to the side panel 86.

Because the vanes 105A-105D extend between the outer edge “Q” of the flap element 52 and the inner edge “R” of the side panel 86, each of the vanes extends across the gap 102.

As illustrated in FIG. 5G, in one embodiment, the outer ends 108 of the vanes 105A, 105B preferably are bent upwardly, and the outer ends 108 of the vanes 105C, 105D preferably are bent downwardly. As a result, when the flap elements 52 are moved downwardly relative to the side panel 86, the outer ends 108 of the vanes 105A, 105B tend to remain engaged with the side panel 86. When the flap elements 52 are moved upwardly relative to the side panel 86, the outer ends 108 of the vanes 105C, 105D tend to remain engaged with the side panel 86.

Those skilled in the art would appreciate that different arrangements of the vanes (i.e., other than the arrangement illustrated in FIG. 5G) may be utilized.

When the system is operated in its normal mode, the heated air flows upwardly through the bale bundles 22, as schematically illustrated in FIG. 5F. In FIG. 5G, the heated air flowing upwardly in the gap 102 is schematically represented by arrow “V₁”. The heated air that flows upwardly into the gap 102 presses the outer ends 108 of the vanes 1050, 105D outwardly, against the wall surface “R”. Accordingly, the seal subassembly 103 prevents (or substantially prevents) heated air from leaking via the gap 102, when the system 20 is in normal operation mode.

Because the gap 102 is sealed with a airtight (or substantially airtight) seal by the side seal subassembly 103, in normal operation, the upwardly-moving air proximal to the sides 75 of the bale bundles 22 rises through the bale bundles to escape therefrom via the top side 88, as schematically represented by arrows “Z₁”, “Z₄” (FIG. 5F).

Similarly, when the system is operated in its reverse mode, the heated air is directed downwardly, and the seal subassembly 103 is configured to prevent, or to substantially prevent, the heated air from flowing through the gap 102 and thereby being diverted away, in part, from flowing through the bale bundles 22. The heated air that is directed downwardly toward the gap 102 is schematically represented by arrow “V₂” in FIG. 5G. The heated air that is directed downwardly into the gap 102 presses the outer ends 108 of the vanes 105A, 105B outwardly, against the wall surface “R” (FIG. 5G). Accordingly, the seal subassembly 103 prevents (or substantially prevents) heated air from leaking past the bale bundles 22 via the gap 102, when the system 20 is in reverse operation mode.

When the system is operated in reverse mode, the downwardly-directed air moves downwardly through the bale bundle, entering via the top side 88. However, the downwardly-directed air at the sides 75 is unable to enter the bale bundle at the top side 88 near the sides 75 because of the flap elements 52.

It will be understood that the downward movement of the air proximal to the sides 75 is in opposite directions to those of arrows “Z₁”, and “Z₄” in FIG. 5F. Because of the side seal subassemblies 103, the downwardly-directed air at the sides 75 of the bale bundles 22 is forced to pass through the bale bundle 22 via the top side 88 thereof.

From the foregoing, it can be seen that the seal subassemblies 103 prevent, or substantially prevent, heated air from escaping upwardly between the flap elements 52 and the side panels 86 respectively adjacent thereto, when the system 20 is operated in its normal mode of operation. It will be understood that, when the system 20 is operated in its reverse mode, the seal subassembly 103 also prevents (or substantially prevents) the heated air from escaping downwardly through the gap 102, i.e., the side seal subassembly 103 prevents the air from going around the bale bundles 22 and requires the air to go through them.

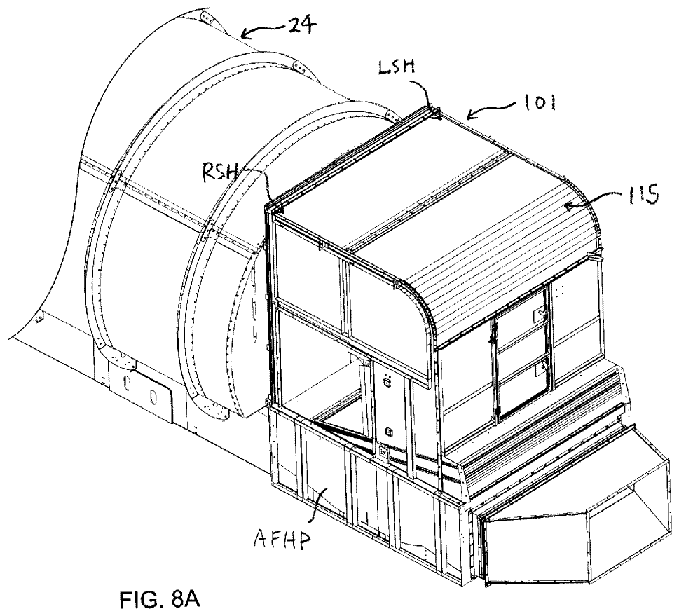

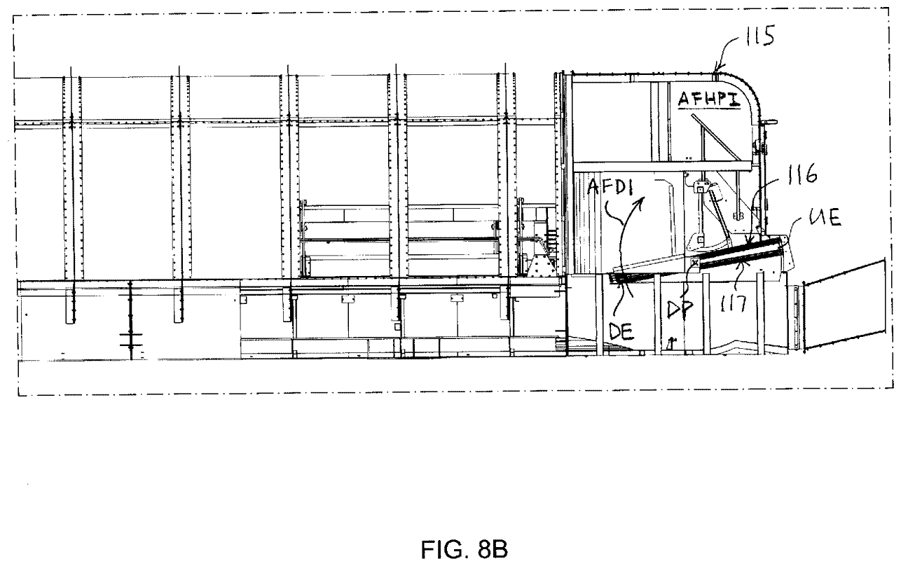

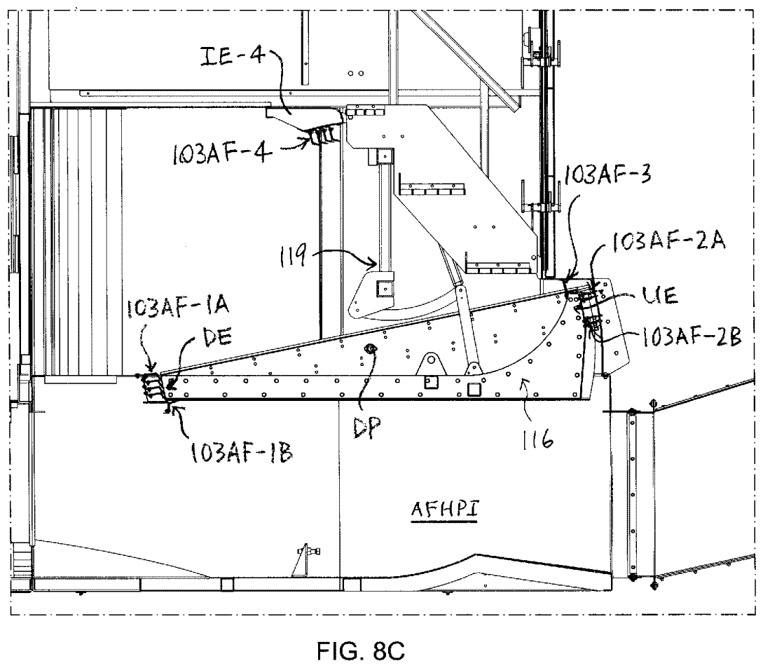

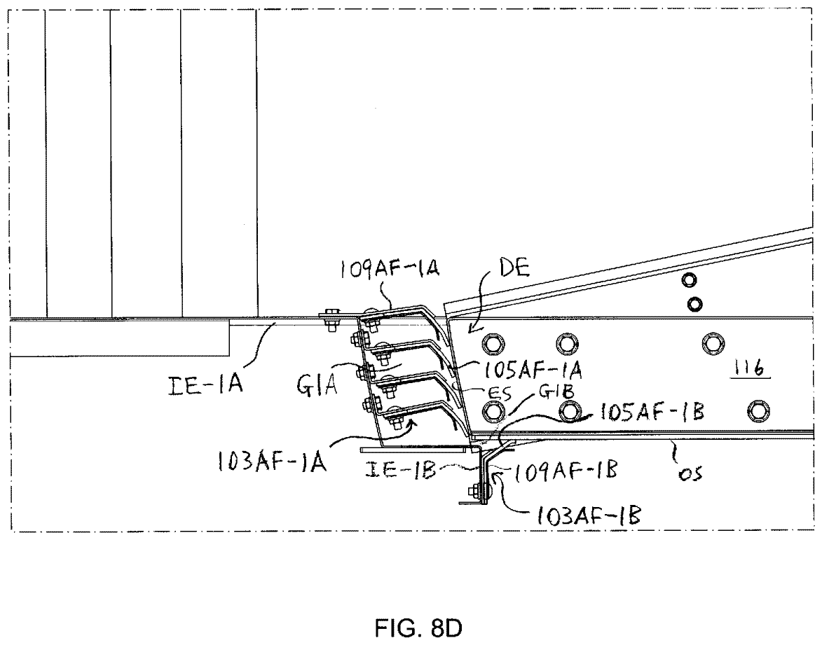

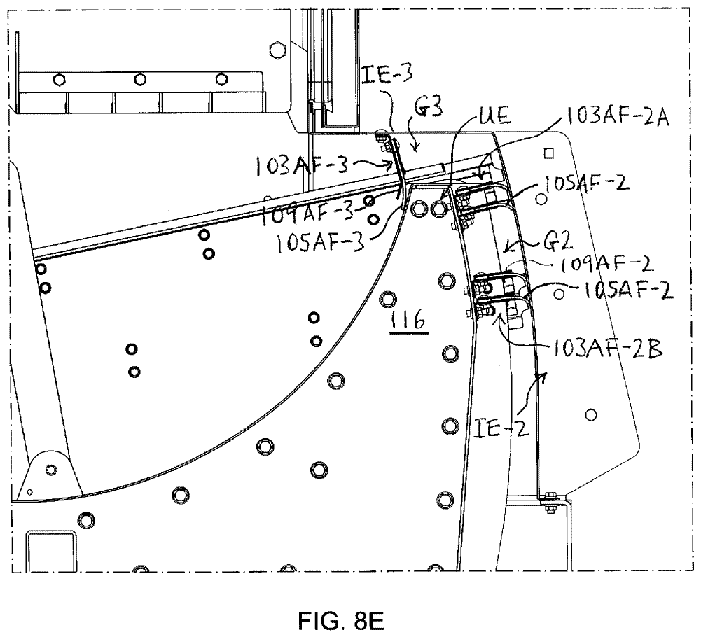

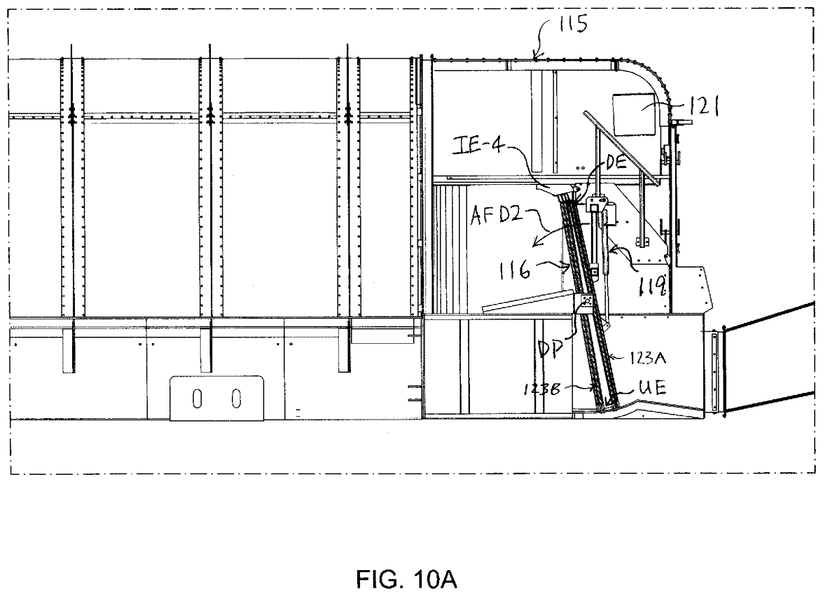

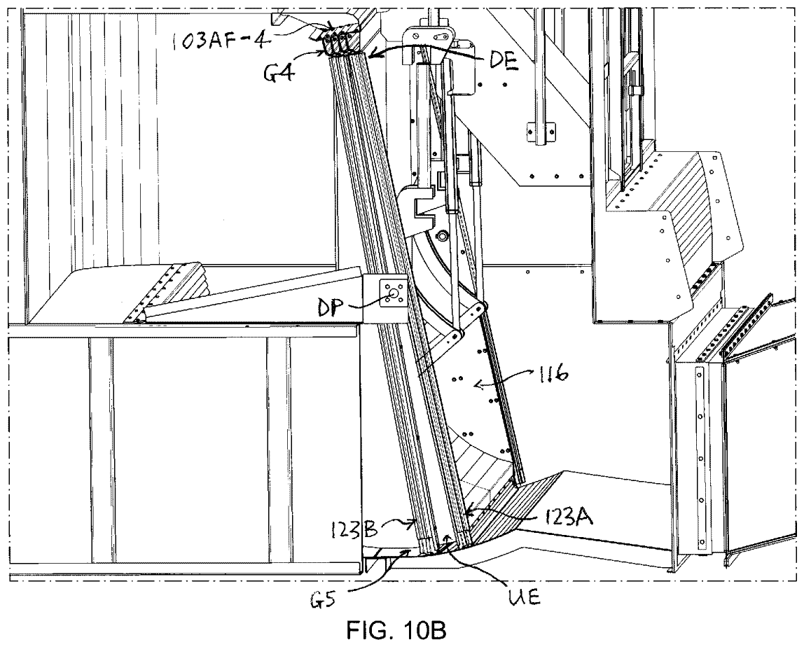

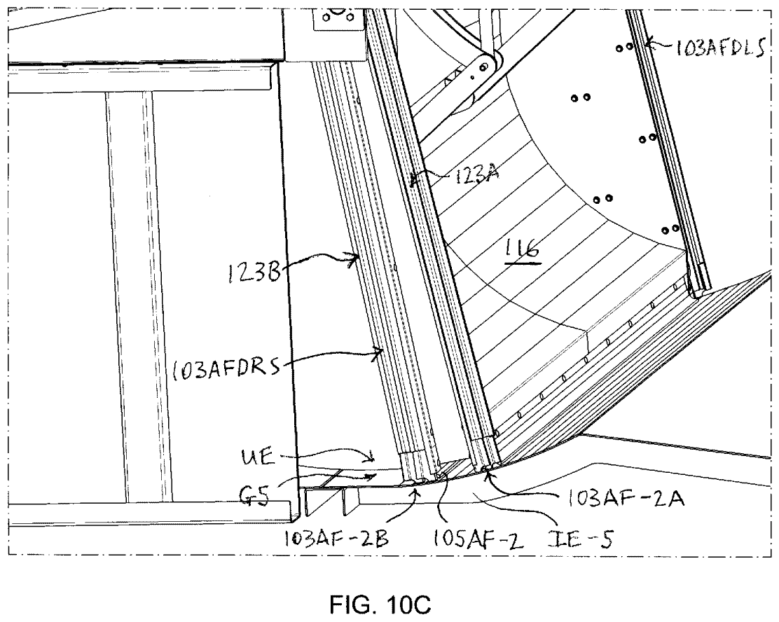

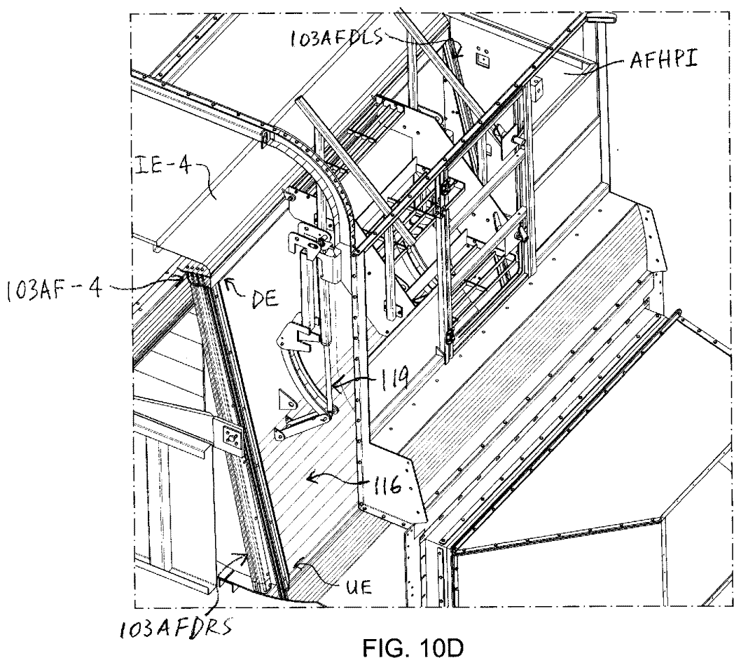

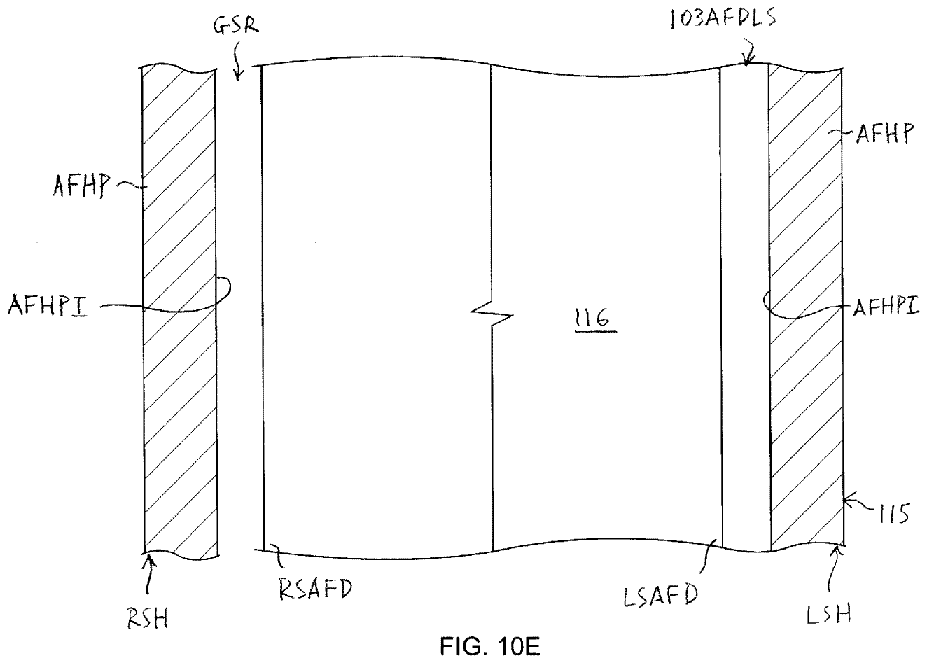

As noted above, the air flow into the lower duct 35 or the upper duct 37, as the case may be, preferably is controlled by the air flow control assembly 101. In one embodiment, the air flow control assembly 101 preferably includes an air flow control housing 115 and an air flow control door 116 located in the air flow control housing 115. Preferably, the air flow control door 116 is movable between a down position (FIGS. 1G, 8B), in which the air flow control door 116 directs the air flow into the lower duct 35, and an up position, in which the air flow control door 116 directs the air flow into the upper duct 37 (FIGS. 1H, 10A).

The left side “LSH” and the right side “RSH” of the air flow control housing 115 are identified in FIG. 8A, consistent with identification of left and right sides of the body assembly 24.

In one embodiment, it is preferred that the air flow control assembly 101 also includes an air flow control door seal assembly 117, to provide a seal between the air flow control door 116 and the air flow control housing 115 when the air flow control door 116 is in the up position, and when the air flow control door 116 is in the down position thereof. Those skilled in the art would appreciate that the seal provided by the air flow control door seal assembly 117 preferably is airtight, or substantially airtight, sealing a gap between the air flow control door 116 and the air flow control housing 115 (FIG. 8B).

As can be seen in FIGS. 8B and 10A, in one embodiment, the air flow control door 116 is pivotable about a pivot point DP between its down and up positions.

The air flow control housing 115 preferably includes a number of internal elements that are formed so that the air flow control door 116 fits inside the internal elements when the air flow control door 116 pivots between the up and down positions thereof. Preferably, the internal elements and the air flow control door 116 are formed to define relatively small gaps therebetween.

As will be described, the air flow control door seal assembly 117 preferably includes seal subassemblies that are configured to provide airtight (or substantially airtight) seals covering the gaps. Some of the seal subassemblies are mounted to the internal elements of the housing, and some of the seal subassemblies are mounted to the air flow control door 116.

As can be seen in FIGS. 8A, 9A, and 11, the air flow control housing 115 preferably includes a number of panels AFHP with interior sides AFHPI that define one or more interior cavities or spaces AFH30 through which the air flow from the fan-heater assembly 106 is directed. It is also preferred that the interior sides AFHPI of the panels AFHP and respective right and left sides RSAFD, LSAFD of the air flow control door 116 are formed to define relatively small side gaps therebetween (FIG. 10E). The side gaps enable the door 116 to pivot about the pivot point DP.

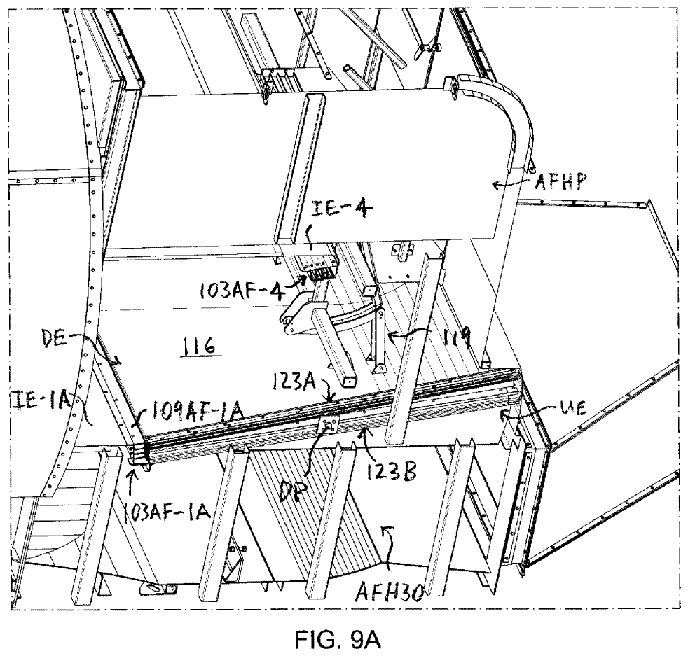

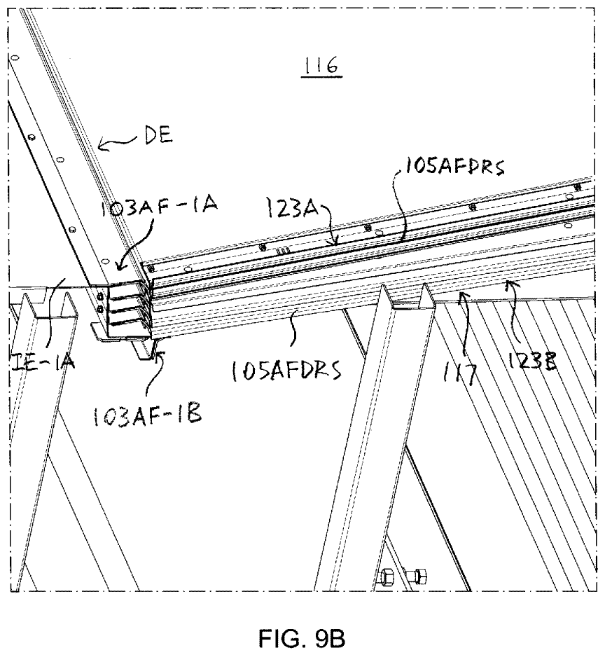

The air flow control door seal assembly 117 preferably includes door side seal subassemblies mounted on each of the right and left sides RSAFD, LSAFD of the door 116 that provide airtight (or substantially airtight) seals of the gaps between the sides of the door 116 and interior sides AFHPI of the panels AFHP that are located at the left and right sides of the housing 115. The right and left door side seal subassemblies 103AFDRS, 103AFDLS are illustrated in FIGS. 9A-11.

In FIG. 10E, only the side gap GSR, defined between the right side RSAFD of the door 116 and the interior side AFHPI of the panel AFHP that is located on the right side “RSH” of the housing 115, is illustrated. It will be understood that the door side seal subassembly 103AFDRS (illustrated in FIGS. 9A-10D and 11), mounted to the right side RSAFD of the door 116, is omitted from FIG. 10E for clarity of illustration, to enable the gap GSR to be shown.

It will also be understood that another side gap (not shown in FIG. 10E) is defined between the left side LSAFD of the door 116 and the interior surface AFHPI of the panel AFHP that is located on the left side “LSH” of the housing 115. The left side gap is substantially the mirror image of the right side gap GSR. It can be seen in FIG. 10E that the door side seal subassembly 103AFDLS mounted to the left side LSAFD of the door 116 covers the left side gap between the left side of the door and the interior side AFHPI of the panel on the left side “LSH” of the housing 115.

As will be described, the door side seal subassemblies 103AFDRS, 103AFDLS preferably include a number of flexible vanes that engage the interior sides AFHPI of the panels AFHP that are located on the right and left sides “RSH”, “LSH” respectively.

As can be seen in FIGS. 8C and 8D, a downstream end DE of the air flow control door 116 and an internal element IE-1A of the air flow control housing 115 define a relatively small gap G1A therebetween, when the door 116 is in its down position. When the door 116 is in its down position, a seal subassembly 103AF-1A that is mounted to the internal element IE-1A is configured to cooperate with the downstream end DE in order to provide an airtight (or substantially airtight) seal of the gap G1A.

Similarly, as can be seen in FIGS. 8C and 8E, an upstream end UE of the air flow control door 116 and internal elements IE-2 and IE-3 of the air flow control housing 115 define a relatively small gaps G₂ and G₃ therebetween, when the door 116 is in its down position. When the door 116 is in its down position, seal subassemblies 103AF-2A, 103AF-2B that are mounted to the air flow control door 116 are configured to cooperate with the internal element IE-2 in order to provide an airtight (or substantially airtight) seal of the gap G₂.

In addition, when the air flow control door 116 is in its down position, a seal subassembly 103AF-3 that is mounted to the internal element IE-3 cooperates with the air flow control door 116 to provide an airtight (or substantially airtight) seal of the gap G₃.

As can be seen in FIGS. 8D and 8E, the seal subassemblies 103AF-1A, 103AF-1B, 103AF-2A, 103AF-2B, and 103AF-3 preferably include one or more vanes 105AF-1A, 105AF-1B, 105AF-2, 105AF-3 respectively that are flexible and that may be supported by sleeves 109AF-1A, 109AF-1B, 109AG-2, 109AF-3 respectively, that urge the respective vanes to engage against a selected surface, to provide the desired seal. For example, as can be seen in FIG. 8D, the vanes 105AF-1A are urged against an end surface ES located at the downstream end DE of the door 116, to close the gap G1A. The seal subassembly 103AF-1B is configured to cooperate with an outer surface OS of the door 116 to close a gap G1B. The vane 105AF-1B is urged against an outer surface OS of the door 116 to close the gap G1B (FIG. 8D) the is defined between the internal element IE-1B and the outer surface OS of the door 116.

It will be understood that the seal subassemblies are included in the air flow control door seal assembly 117.

As can be seen in FIGS. 8B and 10A, in order to move the air flow control door 116 from its down position to its up position, the air flow control door 116 pivots about the pivot point DP. The direction in which the door pivots in or to move it from the down position to the up position is indicated by arrow “AFD1” in FIG. 8B. The direction in which the door pivots when it moves from its up position to its down position is indicated by arrow “AFD2” in FIG. 10A.

Those skilled in the art would appreciate that the movement of the air flow control door 116 between its up and down positions may be controlled by any suitable device. Preferably, the movement is effected by a pivot subassembly 119 that is controlled by a door controller 121 (schematically represented in FIG. 10A), as will be described.

The air flow control door 116 is shown in the up position thereof in FIGS. 10A-10D. As can be seen in FIG. 10B, when the air flow control door 116 is in the up position, the end surface of the door at the downstream end DE is engaged with a seal subassembly 103AF-4 to seal (or to substantially seal) a gap G₄ between the downstream end DE and an internal element IE-4 (FIGS. 10A, 10D). The seal subassembly 103AF-4 is mounted to the internal element IE-4 (FIGS. 10A, 10D). As can be seen in FIG. 10D, the seal subassembly 103AF-4 preferably includes one or more flexible vanes 105AF-4 configured for engagement with the end surface ES of the air flow control door 116 at its downstream end DE. Those skilled in the art would appreciate that the seal subassembly 103AF-4 includes elements thereof similar to those of seal subassembly 103AF-1. The seal subassembly 103AF-4 is included in the air flow control seal assembly 117.

As can be seen in FIG. 10C, when the air flow control door 116 is in the up position thereof, the upstream end UE is positioned proximal to an internal element IE-5, to define a gap G₅ between the upstream end UE and the internal element IE-5. The seal subassemblies 103AF-2A and 103AF-2B are engaged with the internal element IE-5 when the door 116 is in its up position, as shown in FIG. 10C. As noted above, the seal subassemblies 103AF-2A, 103AF-2B preferably include vanes 105AF-2 that engage the internal element IE-5 to provide an airtight (or substantially airtight) seal over the gap G₅.

As noted above, the air flow control seal assembly 117 includes the door side seal subassemblies 103AFDRS, 103AFDLS. It will be understood that the door seal subassemblies are the mirror images of each other. Accordingly, only the door side seal subassembly 103AFDRS will be described in detail below, to simplify the description.

Preferably, the right side door seal subassembly 103AFDRS extends along the right side RSAFD of the air flow control door 116, between the downstream end DE and the upstream end UE of the door 116 (FIG. 9A). As can be seen in FIGS. 9A and 9B, the right side door seal subassembly 103AFDRS preferably includes first and second portions, identified in FIG. 9A by reference characters 123A, 123B respectively.

As can be seen, e.g., in FIG. 9B, each of the first and second portions 123A, 123B preferably includes a number of vanes 105AFDS. The vanes 105AFDS are configured for engagement with the interior sides AFHPI of panels AFHP, to provide airtight (or substantially airtight) seals of the gap GSR (FIG. 10E) between the right side RSAFD of the air flow control door 116 and the interior side AFHPI of the housing panel AFHP that is located adjacent thereto.

As described above, after the system 20 has been in normal operation mode for some time, it may be found that the moisture content of the bale bundles in the lower portions thereof is relatively low, and the moisture content in the higher portions is relatively high, in relation to the preselected target moisture content. Accordingly, it may be desired at that point to cause the system 20 to be operated in reverse operation mode instead. When it is desired to change the mode of operation from normal to reverse, the appropriate command is generated, and transmitted to the door controller 121. It will be understood that such command may be generated and transmitted in any suitable manner.

Upon the appropriate command being transmitted to the door controller 121, the door controller 121 causes the pivot subassembly 119 to be actuated, in order to cause the door 116 to pivot about its pivot point DP from the down position to the up position thereof. The door controller 121 and pivot subassembly 119 are conventional, and further description thereof is therefore unnecessary.

Similarly, if the system 20 is operating in reverse operation mode and it is required to change to normal operation mode, the appropriate signal preferably is transmitted to the door controller 121, which causes the pivot subassembly 119 to pivot the door 116 about its pivot point DP to the down position thereof.

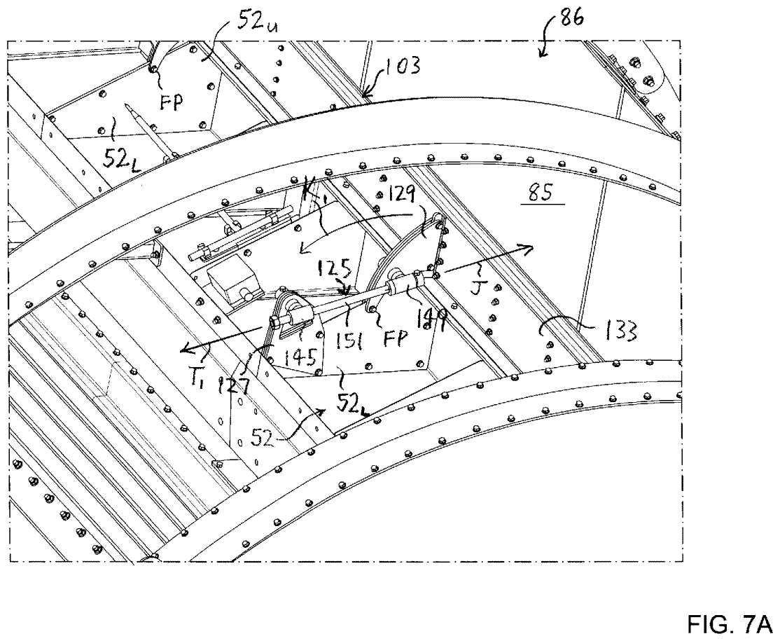

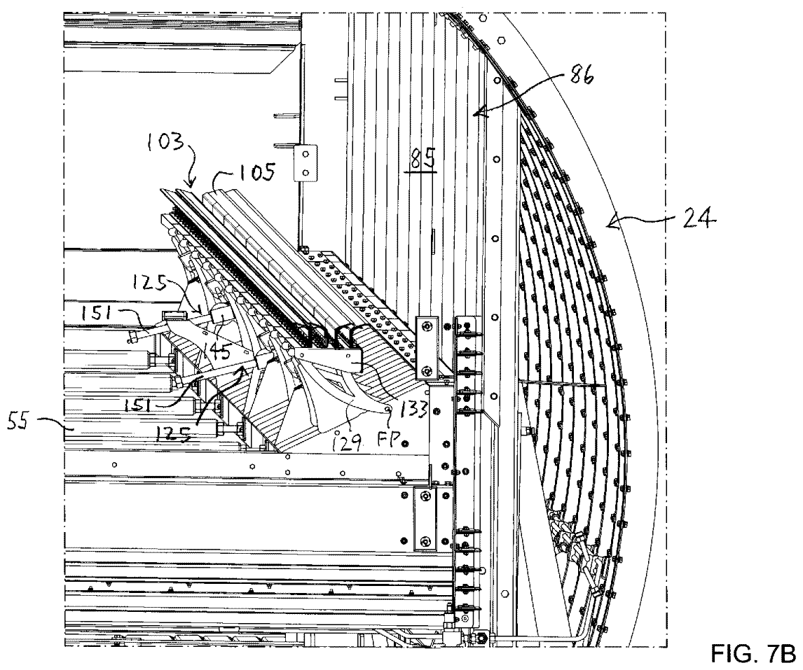

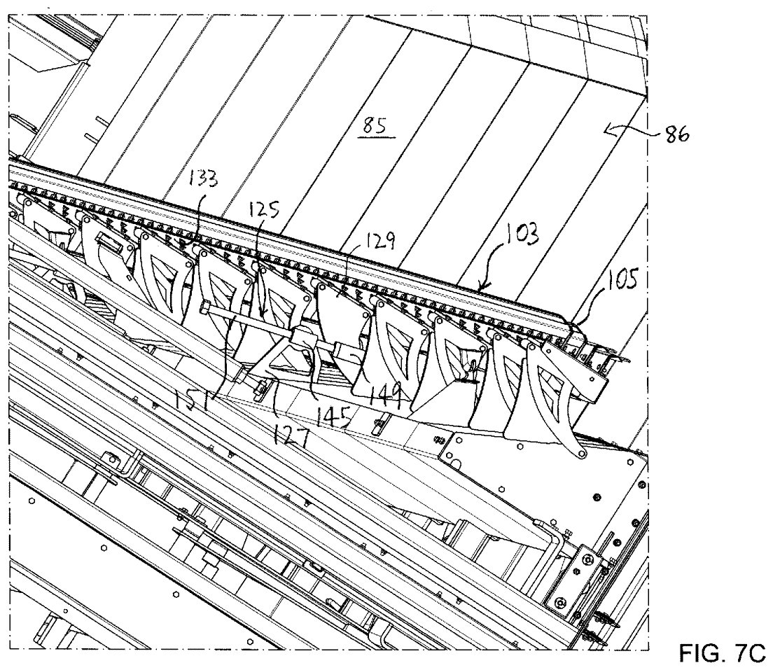

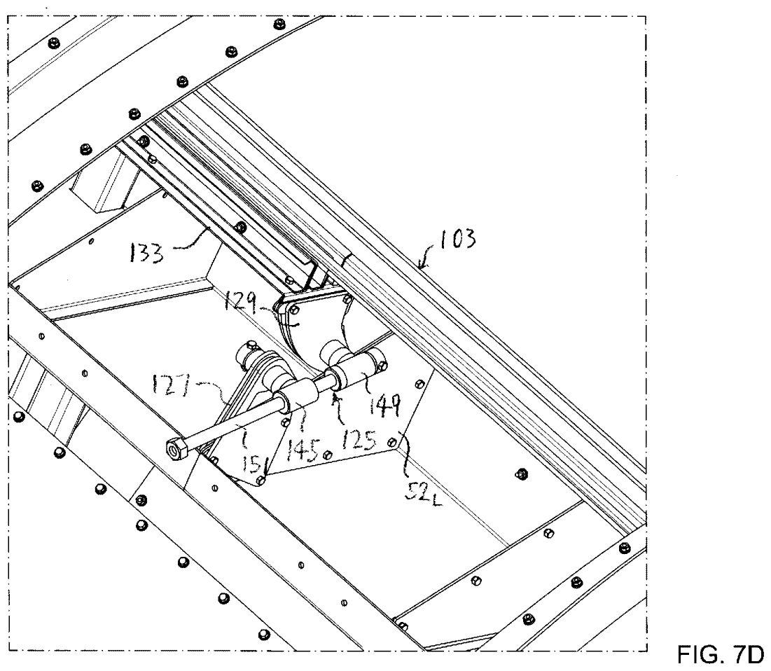

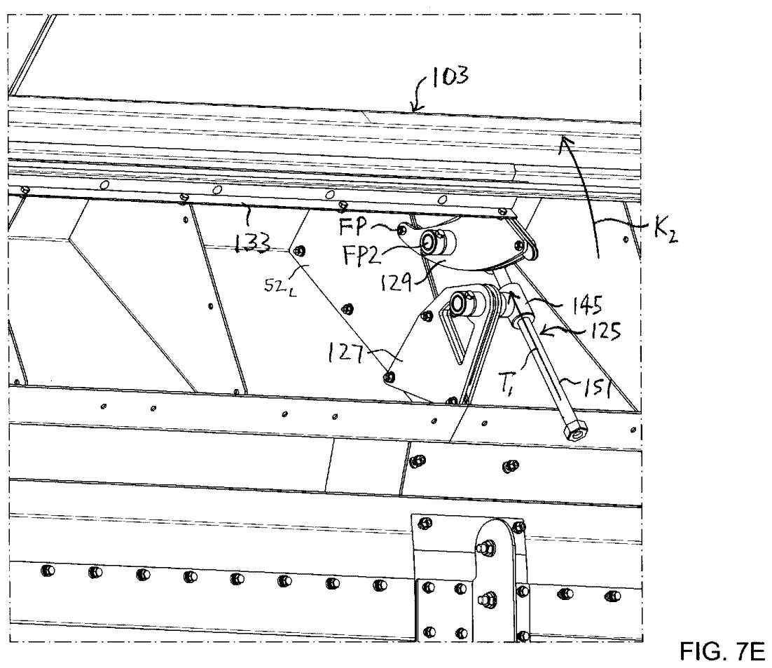

In one embodiment, the system 20 preferably includes a flap element adjustment assembly 125 that is configured for movement thereof between a closed position (FIG. 7A) and an open position thereof (FIGS. 7B-7E).

As described above, the flap elements 52 on each of the left and right sides of the body assembly 24 extend between the first and second ends 26, 28 thereof. It will be understood that the system 20 preferably includes at least one flap element adjustment assembly 125 on each of the left and right flap elements 52. Preferably, a number of flap element adjustment assemblies 125 are mounted to the left and right flap elements 52, spaced apart along the lengths of the flap elements 52.

As can be seen in FIG. 7A, in one embodiment, the flap element adjustment assembly 125 preferably is connected with an inner plate 127 and a first plate 129, The inner plate 127 is mounted to the lower portion 52, and the first plate 129 is pivotably mounted to the lower portion 52. It will be understood that, in the embodiment of the invention illustrated in FIGS. 7A-7E, the upper flap element 52u is replaced by the inner plate 127, the first plate 129, and a second plate 133.

As can also be seen in FIG. 7A, a number of the lower portions 52, preferably are located spaced apart along the flap element 52. In one embodiment, at some of the lower portions 52_{L}, respective first plates 129 are pivotably mounted thereto. The pivot points about which the upper portions pivot, relative to the respective lower portions, are identified by reference character FP.

Preferably, the flap element adjustment assembly 125 is pivotably connected to the first plate 129. The flap element 52 preferably also includes the second plate 133 that is secured to the first plate 129. As can be seen in FIG. 7A, it is preferred that the second plate 133 is positioned orthogonal to the first plate 129.

As can be seen in FIG. 7A, the side seal assembly 103 preferably is mounted to the second plate 133. It will be understood that the side seal assembly 103 includes vanes 105 (FIG. 5G) that are configured for engagement with the internal side 85 of the side panel 86, when the flap element adjustment assembly 125 is in its closed position.

In one embodiment, the flap element adjustment assembly 125 preferably includes a first sleeve 145 and a second sleeve 149, as well as a rod 151 receivable in the sleeves 145, 149. Preferably, the rod 151 is threadably engaged with the first sleeve 145, so that rotation of the rod 151 about its axis (e.g., in a clockwise direction) causes the rod 151 to move in the direction indicated by arrow “J” or, alternatively, rotation of the rod 151 in the opposite direction (e.g., in a counter-clockwise direction) causes the rod 151 to move inwardly, i.e., in a direction that is generally opposed to the direction indicated by arrow “J” (FIGS. 7A-7E).

From the foregoing, it can be seen that, when the flap element adjustment assembly 125 is in its closed position, the flap element adjustment assembly 125 may be used to urge the second plate 133 in the direction indicated by arrow “J”, and thereby to urge the vanes 105 of the side seal assembly 103 against the internal side 85 of the side panel 86. Alternatively, when the flap element adjustment assembly 125 is in its closed position, the extent to which the second plate 133 is urged thereby toward the panel 86 may be decreased, e.g., by rotating the rod 151 in a counter-clockwise direction.

In order to move the flap element adjustment assembly 125 from the closed position to the open position, the rod 151 is rotated (e.g., in a counter-clockwise direction) sufficiently to move it inwardly, as indicated by arrow “T₁” (FIG. 7A). When the rod 151 is moved sufficiently far inwardly, the movement of the rod 151 causes the flap element adjustment assembly 125 to move to its open position (FIGS. 7B-7E). Specifically, the movement of the rod 151 sufficiently far inwardly causes the first plate 129 to pivot in the direction generally indicated by arrow “K₁” about the pivot point FP. It will be understood that such pivoting movement also causes the first plate 129 to pivot slightly relative to the second sleeve 149, about a second pivot point FP2 (FIG. 7E).

As can be seen in FIGS. 7B-7E, when the flap element adjustment assembly 125 is in its open position, the side seal assembly 103 is accessible for service, e.g., repair, or replacement thereof. For example, the vanes 105 are accessible, and may be repaired or replaced (FIG. 7B). It will be understood that a number of elements, or portions of elements, are omitted from FIGS. 7A-7E for clarity of illustration.

Movement of the flap element adjustment assembly 125 from the open position to the closed position is illustrated in FIG. 7E. As can be seen in FIG. 7E, when the rod 151 is rotated (e.g., in a clockwise direction), the rod 151 moves in the direction indicated by arrow “T₂”, pushing the first plate 129 toward the panel, causing the first plate 129 to rotate about the pivot point FP, as generally indicated by arrow “K₂”. In addition, the second sleeve 149 rotates a small distance about the pivot point FP2, as the flap element adjustment assembly 125 moves from the open position to the closed position thereof. Once the flap element adjustment assembly 125 is in the closed position thereof, the flap element adjustment assembly 125 may be used to urge the second plate 133 toward the internal side 85 of the proximal side panel 86 (as described above) as required, to ensure that the side seal subassembly 103 provides an airtight (or substantially airtight) seal against the internal side 85 of the panel 86.

Those skilled in the art would appreciate that after the flap element adjustment assembly 125 has been in its closed position for some time, it may be necessary to adjust the flap element adjustment assembly 125 by rotating the rod 151 (e.g., in the clockwise direction), in order to urge the second plate 133 toward the panel 86, so as to maintain the seal provided by the side seal subassembly 103.

From the foregoing, it can be seen that, in one embodiment, the invention provides a method of changing a moisture content of one or more bale bundles, each bale bundle including a number of bales. The method includes positioning the bale bundles on the floor assembly 32 and, with the engagement assembly 38, at least partially compressing the bale bundles against the floor assembly. An air flow is directed into a selected one of the lower duct 35 and the upper duct 37 and through the bale bundles positioned on the floor assembly while the bale bundles are at least partially compressed by the engagement assembly, for changing the moisture content of the bale bundles.

As described above, the air flow preferably is produced by one or more fans that are controlled by the fan controller 113. Preferably, the moisture content of the bale bundles is measured. With the fan controller, the one or more fans are de-energized upon the moisture content of the bale bundles being equal to a preselected target moisture content.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A system (20) comprising:
a body assembly (24) extending between first and second ends (26, 28) thereof, the body assembly comprising respective left and right sides (LS, RS) thereof and having at least one interior surface partially defining an interior space (30) therein;
a floor assembly (32) with a plurality of openings (34) therein located in the interior space for supporting at least one bale bundle positioned thereon, the floor assembly being located in the interior space to divide the interior space into a lower duct (35) below the floor assembly and an upper portion (36) above the floor assembly, wherein when said at least one bale bundle is positioned on the floor assembly, said at least one bale bundle partially defines an upper duct in the upper portion between said at least one bale bundle and a portion of said at least one interior surface; and
an engagement assembly (38) extending between the first and second ends and configured for at least partially compressing said at least one bale bundle positioned on the floor assembly, wherein an air flow is directed through said at least one bale bundle while said at least one bale bundle is at least partially compressed thereby, for changing a moisture content of said at least one bale bundle.

2. The system according to claim 1 in which:
the engagement assembly (38) comprises:
an upper subassembly (46) comprising left and right flap elements (52) positioned proximal to the left and right sides of the body assembly (24) respectively, said flap elements (52) being configured for engaging one or more selected portions of a top side (88) of said at least one bale bundle (22) positioned on the floor assembly;
an intermediate subassembly (48) for supporting the upper subassembly (46);
the intermediate subassembly being configured for moving the upper subassembly between raised and lowered positions thereof, wherein the engagement assembly is in a disengaged condition thereof when the upper subassembly is in the raised position, and the engagement assembly is in an engaged condition thereof, for engagement with said at least one bale bundle positioned on the floor assembly, when the upper subassembly is in the lowered position thereof;
a support subassembly (50) for at least partially supporting the upper subassembly (46) and the intermediate subassembly (48);
the support subassembly (50) comprising left and right side panels (86) located between the left and right sides (LS, RS) of the body assembly and the left and right flap elements respectively and extending between the first and second ends (26, 28), said side panels (86) comprising respective internal sides (85) thereof that are configured to be located proximal to respective left and right sides (75) of said at least one bale bundle (22) when said at least one bale bundle is positioned on the floor assembly;
wherein, when said at least one bale bundle is positioned on the floor assembly and the engagement assembly is in the engaged condition, the left flap element (52) and the left side panel (86) define a left gap (102) therebetween, and the right flap element (52) and the right side panel (86) define a right gap (102) therebetween; and
the upper subassembly (46) additionally comprises at least one left side seal subassembly (103) configured for sealing the left gap (102) and at least one right side seal subassembly (103) configured for sealing the right gap (102), to impede air flowing through the left and right gaps (102) respectively.

3. The system according to claim 2 in which the left and right flap elements (52) comprise respective engagement surfaces (53) thereof for engaging the one or more selected portions of the top sides of said at least one bale bundle positioned on the floor assembly, for at least partially compressing said at least one bale bundle against the floor assembly when the engagement assembly is in the engaged condition.

4. The system according to claim 3 in which the upper subassembly comprises a plurality of cross-members, each said cross-member connecting the left and right flap elements, wherein the air flow is permitted to pass between said cross-members and through said at least one bale bundle positioned on the floor assembly when the engagement assembly is in the engaged condition.

5. The system according to claim 4 in which the intermediate subassembly (48) comprises left and right side bars (74) that are configured for engagement with the left and right sides (75) respectively of said at least one bale bundle (22) positioned on the floor assembly when the engagement assembly (38) is in the engaged condition.

6. The system according to claim 5 in which the intermediate subassembly (48) is configured for initial engagement of the side bars (74) with the left and right sides (75) of said at least one bale bundle (22) respectively as the upper subassembly (46) moves from the raised position to the lowered position thereof when the flap elements (52) engage the one or more selected portions of the top side (88) of said at least one bale bundle positioned on the floor assembly (32).

7. The system according to claim 1 additionally comprising at least one fan, for producing the air flow.

8. The system according to claim 7 additionally comprising at least one heater, for heating air in the air flow to a predetermined temperature.

9. The system according to claim 7 additionally comprising:
a fan controller for controlling said at least one fan; and
at least one moisture measurement device, for measuring the moisture content of said at least one bale bundle positioned on the floor assembly, said fan controller being configured for de-energizing said at least one fan when the moisture content is equal to a preselected target moisture content.

10. The system according to claim 9 additionally comprising an air flow control assembly configured to direct the air flow into a selected one of the lower duct and the upper duct in order that the moisture content of said at least one bale bundle is equal to the preselected target moisture content throughout said at least one bale bundle.

11. The system according to claim 10 in which the air flow control assembly comprises:
an air flow control housing;
an air flow control door located in the air flow control housing, and movable between:
a down position, in which the air flow control door directs the air flow into the lower duct; and
an up position, in which the air flow control door directs the air flow into the upper duct.

12. The system according to claim 11 in which the air flow control assembly comprises an air flow control door seal assembly to provide a seal between the air flow control door and the air flow control housing when the air flow control door is in the raised position and when the air flow control door is in the lowered position thereof.

13. A method for changing a moisture content of at least one bale bundle comprising a plurality of bales, the method comprising:
(a) providing a body assembly (24) extending between first and second ends (26, 28) thereof, the body assembly comprising respective left and right sides (LS, RS) thereof and having at least one interior surface partially defining an interior space (30) therein;
(b) providing a floor assembly (32) with a plurality of openings (34) therein located in the interior space for supporting at least one bale bundle positioned thereon, the floor assembly being located in the interior space to divide the interior space into a lower duct (35) below the floor assembly and an upper portion (36) above the floor assembly, wherein when said at least one bale bundle is positioned on the floor assembly, said at least one bale bundle defines an upper duct in the upper portion between said at least one bale bundle and a portion of said at least one interior surface that is at least partially above said at least one bale bundle;
(c) positioning said at least one bale bundle on the floor assembly;
(d) providing an engagement assembly (38) extending between the first and second ends and configured for at least partially compressing said at least one bale bundle positioned on the floor assembly;
(f) with the engagement assembly, at least partially compressing said at least one bale bundle against the floor assembly; and
(f) directing an air flow into a selected one of the lower duct and the upper duct and through said at least one bale bundle positioned on the floor assembly while said at least one bale bundle is at least partially compressed by the engagement assembly, for changing the moisture content of said at least one bale bundle.

14. The method according to claim 13 in which the air flow is produced by at least one fan that is controlled by a fan controller, the method additionally comprising:
(g) measuring the moisture content of said at least one bale bundle on the floor assembly; and
(h) with the fan controller, de-energizing said at least one fan upon the moisture content of said at least one bale bundle being equal to a preselected target moisture content.
